(19) United States
(12) Patent Application Publication
(10) Pub. No.: US 2024/0369949 A1
(43) Pub. Date: Nov. 7, 2024

(54) TONER AND PROCESS CARTRIDGE

(71) Applicant: CANON KABUSHIKI KAISHA, Tokyo (JP)

(72) Inventors: TAIJI KATSURA, Shizuoka (JP); SHOHEI SHIBAHARA, Shizuoka (JP); TAKUHO SATO, Shizuoka (JP)

(21) Appl. No.: 18/645,768

(22) Filed: Apr. 25, 2024

(30) Foreign Application Priority Data
May 2, 2023 (JP) 2023-076051

(51) Int. Cl. G03G 9/097; G03G 9/087; G03G 21/00

(52) U.S. Cl. CPC G03G 9/09708; G03G 9/08755; G03G 21/0011

(57) ABSTRACT

A toner comprising a toner particle comprising a binder resin, and an external additive, wherein the external additive comprises a hydrotalcite particle, the toner comprises fumaric acid, and when a content of the hydrotalcite particle in the toner on a mass basis is denoted by a (%) and a content of the fumaric acid in the toner on a mass basis is denoted by b (%), then the a and the b satisfy formula (1) below:

$$1. \leq a / b \leq 300. . \qquad ( 1 )$$

### BACKGROUND OF THE INVENTION

### Field of the Invention

The present disclosure relates to a toner and a process cartridge which are used in image-forming methods such as an electrophotographic method.

### Description of the Related Art

Improvements in the speed and environmental stability of copiers and printers have progressed in recent years, there have been demands for toners able to provide stable image quality even at high printing speeds and in cases where changes in usage environment occur, such as low temperature low humidity environments and high temperature high humidity environments.

In the electrophotographic method, a latent image bearing member is first charged using a variety of means, and an electrostatic latent image is then formed on the surface of the latent image bearing member through exposure to light. Next, the electrostatic latent image is developed to form a toner image, the toner image is transferred to a transfer material such as paper, and the toner image is fixed on the transfer material through heat and pressure so as to obtain a copied article or a print.

In this type of image formation process, toner that remains on the surface of the latent image bearing member after the toner image has been transferred has to be removed (cleaned) using some sort of method.

As the method for cleaning toner remaining on a latent image bearing member, a method including bringing the surface of a latent image bearing member into contact with the edge of a cleaning blade, which is formed from an elastic material such as a urethane rubber, is widely used. By increasing the contact pressure of the cleaning blade, cleaning performance is improved, but abnormal noises tend to occur as a result of blade chipping, abrasion of the latent image bearing member and vibration of the blade. These problems occur more readily if processing speed is increased in order to increase printing speed. That is, in the main body of a high-speed copier or printer, it tends to be difficult to achieve a balance between cleaning performance and durability of members. With this background in mind, there is a need for further improvements in terms of toner cleaning performance.

to address the problems mentioned above, Japanese Patent Application Publication No. 2017-219823, for example, discloses a toner that contains both positively charged lubricant particles and negatively charged lubricant particles. This document indicates that because the positively charged lubricant particles and negatively charged lubricant particles are laid, respectively, on latent parts and non-latent parts of a latent image bearing member, it is possible to achieve favorable cleaning performance regardless of image line rate.

Japanese Patent Application Publication No. 2019-184795 discloses that by incorporating two or more types of strontium titanate fine particles having different particle diameters as external additives, it is possible to form a deposition layer (hereinafter referred to as a blocking layer) of the external additives on a cleaning part and improve toner cleaning performance.

### SUMMARY OF THE INVENTION

However, in cases where measures such as those described in the documents above are used, there is still room for improvement in terms of cleaning performance in cases where changes occur in the environment of a cleaning part in a high speed copier or the printer. Specifically, it has been ascertained that in cases where changes occur in the temperature and humidity of a usage environment, a blocking layer of external additive is not retained, and faulty cleaning occurs at start-up.

The present disclosure provides a toner and a process cartridge that exhibit favorable cleaning performance even in cases where changes occur in the temperature and humidity of a usage environment.

The present disclosure relates to a toner comprising a toner particle comprising a binder resin, and an external additive, wherein
the external additive comprises a hydrotalcite particle,
the toner comprises fumaric acid, and
when a content of the hydrotalcite particle in the toner on a mass basis is denoted by a (%) and a content of the fumaric acid in the toner on a mass basis is denoted by b (%),
then the a and the b satisfy formula (1) below:

$$1. \leq a / b \leq 300. . \qquad ( 1 )$$

The present disclosure can provide a toner and a process cartridge that exhibit favorable cleaning performance even in cases where changes occur in the temperature and humidity of a usage environment.

Further features of the present invention will become apparent from the following description of exemplary embodiments with reference to the attached drawings.

### BRIEF DESCRIPTION OF THE DRAWINGS

FIGS. 1A to 1C are schematic diagrams of EDS line analysis in STEM-EDS mapping analysis.

### DESCRIPTION OF THE EMBODIMENTS

The present disclosure will now be explained in greater detail through the use of embodiments, but is not limited to these embodiments.

Moreover, the terms “from XX to YY” and “XX to YY”, which indicate numerical ranges, mean numerical ranges that include the lower limits and upper limits that are the end points of the ranges. In cases where numerical ranges are indicated incrementally, upper limits and lower limits of the numerical ranges can be arbitrarily combined.

The present disclosure relates to a toner comprising a toner particle comprising a binder resin, and an external additive, wherein
the external additive comprises a hydrotalcite particle,
the toner comprises fumaric acid, and
when a content of the hydrotalcite particle in the toner on a mass basis is denoted by a (%) and a content of the fumaric acid in the toner on a mass basis is denoted by b (%),
then the a and the b satisfy formula (1) below:

$$1. \leq a / b \leq 300. . \qquad ( 1 )$$

By containing hydrotalcite particles and fumaric acid at a ratio that satisfies formula (1), it is possible to obtain a toner that exhibits good cleaning performance even in cases where changes occur in the temperature and humidity of a usage environment. The inventors of the present invention think that the mechanism by which this effect is achieved is as follows.

In order to suppress slip-through of the toner or external additive at a cleaning blade part, it is effective for the blocking layer formed at a contact region between the latent image bearing member surface and the cleaning blade (hereinafter referred to as the cleaning blade nip part) to be retained in such a way as to not disintegrate.

It is thought that it is important for the external additive supplied from the toner to be a primary component of the material that forms the blocking layer in order to control aggregation of the external additive and stabilize the blocking layer. If aggregation between the external additive is weak, the blocking layer readily disintegrates and cleaning performance tends to deteriorate. However, a strong degree of aggregation is not necessarily more favorable, and it is thought that an appropriate degree of flexibility is important in order to adapt to dynamic changes of the cleaning blade nip part.

In addition, in cases where the formed blocking layer undergoes changes in terms of temperature and humidity, the effects of moisture can cause changes in the state of the blocking layer and result in reduced stability. The inventors of the present invention think that in cases where changes in terms of temperature and humidity occur, maintaining a suitable degree of aggregation between the external additive is important for achieving environmental stability of cleaning.

In the present disclosure, fumaric acid contained in the toner migrates to the hydrotalcite particles, and forms a blocking layer having a suitable degree of aggregation at the time of cleaning. The hydrotalcite particles, which have a high effect as an acid acceptor, readily bind to the fumaric acid, and because the hydrotalcite particles are present as an external additive, the fumaric acid readily migrates from the toner surface to the blocking layer. Fumaric acid has a dicarboxylic acid structure, forms a complex with aluminum and magnesium in the blocking layer that contains the hydrotalcite particles, and maintains a suitable degree of aggregation. Meanwhile, fumaric acid has low solubility in water compared with dicarboxylic acids having a similar molecular weight, such as maleic acid, and is therefore thought to be unlikely to be affected by changes in temperature and humidity and can form a blocking layer having high environmental stability.

If the content of the hydrotalcite particles in the toner on a mass basis is denoted by a (%) and the content of the fumaric acid in the toner on a mass basis is denoted by b (%), then a and b must satisfy formula (1) below.

$$1. \leq a / b \leq 300. \qquad Formula ( 1 )$$

By controlling the value of a/b within the range of formula (1), it is possible to obtain a toner having good cleaning performance even in cases where changes occur in the temperature and humidity of a usage environment. If the value of a/b is less than 1.0, the amount of fumaric acid relative to the hydrotalcite particles becomes too high, and the flexibility of the blocking layer is insufficient. In addition, if the value of a/b exceeds 300.0, the amount of fumaric acid relative to the hydrotalcite particles is insufficient, and the cohesive strength of the blocking layer is insufficient. Moreover, the amount of hydrotalcite particles tends to become excessive, charging performance deteriorates, and fogging may occur.

By appropriately controlling the ratio of the hydrotalcite particles and the fumaric acid, it is possible to form a blocking layer which has an appropriate degree of aggregation and high environmental stability, and it is also possible to achieve good charging performance. The value of a/b is more preferably from 1.0 to 170.0, and further preferably from 1.0 to 20.0.

The toner contains the hydrotalcite particles as an external additive.

The hydrotalcite particles can be a substance represented by structural formula (2) below.

M²⁺_{y}M³⁺ₓ(OH)₂Aⁿ⁻_{(x/n)}·mH₂O Formula (2):

Here, 0<x<0.5, y=1−x, and m>0.

M²⁺ and M³⁺ denote a divalent metal and a trivalent metal, respectively.

M²⁺ is preferably at least one type of divalent metal ion selected from the group consisting of Mg, Zn, Ca, Ba, Ni, Sr, Cu and Fe.

M³⁺ is preferably at least one type of trivalent metal ion selected from the group consisting of Al, B, Ga, Fe, Co and In.

Aⁿ⁻ is an anion having a valency of n, examples of which include CO₃²⁻, OH⁻, Cl⁻, I⁻, F⁻, Br⁻, SO₄²⁻, HCO₃⁻, CH₃COO⁻ and NO₃⁻, and one of these may be present in isolation, or multiple types thereof may be present.

The hydrotalcite particles preferably contain at least Al as M³⁺ and preferably contain at least Mg as M²⁺. In addition, the hydrotalcite particles preferably contain at least F as Aⁿ⁻. That is, the hydrotalcite particles preferably contain magnesium and aluminum. In addition, the hydrotalcite particles preferably contain fluorine, aluminum and magnesium.

It is more preferable for the hydrotalcite particles to contain fluorine in the inner part thereof. By containing fluorine in the inner part thereof, positive charging of the hydrotalcite particles is suppressed and electrostatic aggregation between hydrotalcite particles is suppressed. Electrostatic aggregation between hydrotalcite particles in the blocking layer is suppressed, but interactions between hydrotalcite particles and fumaric acid are further enhanced. Because aggregation in the blocking layer caused by electrostatic aggregation tends to be affected by moisture, it is possible to form a blocking layer that is less likely to be affected by moisture by using hydrotalcite particles that contain fluorine in the inner part thereof.

Specific examples of the hydrotalcite particles include: Mg_{4.3}Al₂(OH)_{12.6}CO₃·mH₂O, Mg_{8.6}Al₄(OH)_{25.2}F₂CO₃·mH₂O and Mg₁₂Al₄(OH)₃₂F₂CO₃·mH₂O.

The hydrotalcite particles may be a solid solution containing a plurality of different elements. In addition, the hydrotalcite particles may contain a small amount of a monovalent metal.

The concentration ratio of the number of magnesium atoms relative to aluminum atoms (Mg/Al element ratio) in the hydrotalcite particles, as determined by primary component mapping of the hydrotalcite particles in STEM-EDS mapping analysis of the toner, is preferably 1.5 to 4.0, more preferably 1.6 to 3.8, and further preferably 2.1 to 3.8.

If the Mg/Al ratio falls within the range mentioned above, charging performance improves and fogging can be easily suppressed. The Mg/Al ratio can be controlled by adjusting amounts of raw materials when hydrotalcite is produced.

Fluorine and aluminum are preferably present in the inner part of the hydrotalcite particles in line analysis in STEM-EDS mapping analysis of the toner. It can be confirmed by STEM-EDS that fluorine is intercalated between layers in the layered structure of the hydrotalcite particles.

In addition, the concentration ratio of the number of fluorine atoms relative to aluminum atoms (F/Al element ratio) in the hydrotalcite particles, as determined by primary component mapping of the hydrotalcite particles in STEM-EDS mapping analysis of the toner, is preferably 0.01 to 0.60, and more preferably 0.02 to 0.50. If the value of F/Al is 0.01 or more, the advantageous effects mentioned above are readily achieved by hydrotalcite particles that contain fluorine in the inner part thereof. In addition, if the value of F/Al is 0.60 or less, a decrease in the charging performance of the toner tends to be suppressed.

In addition, from the perspective of stabilizing charging performance, the hydrotalcite particles preferably contain water in the molecule, and it is more preferable for 0.1<m<0.6 in formula (2).

The number average particle diameter of primary particles of the hydrotalcite particles is preferably 50 to 1200 nm, more preferably 60 to 1000 nm, and further preferably 100 to 800 nm. If this particle diameter is 1200 nm or less, good toner fluidity tends to be maintained.

The hydrotalcite particles may hydrophobically treated using a surface treatment agent. Higher fatty acids, coupling agents, esters and oils such as silicone oils can be used as surface treatment agents. Of these, higher fatty acids are preferably used, and specific examples of these include stearic acid, oleic acid and lauric acid.

The content a (%) of the hydrotalcite particles in the toner on a mass basis is not particularly limited as long as the value of a/b falls within the range in formula (1) above. The content a (%) is preferably 0.01 to 3.00%, more preferably 0.05 to 0.50%, and further preferably 0.05 to 0.40%. In addition, the content of the hydrotalcite particles is preferably 0.01 to 3.00 parts by mass, more preferably 0.05 to 0.50 parts by mass, and further preferably 0.05 to 0.40 parts by mass, relative to 100 parts by mass of the toner particle. The content of the hydrotalcite particles can be quantitatively determined by X-Ray fluorescence analysis using a calibration curve prepared from a standard sample. This content can be controlled by altering the amount of the hydrotalcite particles added to the toner particles.

The toner contains fumaric acid. The content b (%) of fumaric acid in the toner on a mass basis is not particularly limited as long as formula (1) is satisfied, but is preferably 0.003 to 0.120%, and more preferably 0.015 to 0.105%. The content of fumaric acid in the toner on a mass basis can be measured using the method described below.

When the content in the toner on a mass basis of fumaric acid, which is extracted from the toner using methanol, is denoted by f1(%), the value of f1 is preferably 0.0003 to 0.0100%, more preferably 0.0006 to 0.0090%, and further preferably 0.0010 to 0.0084%. Methanol hardly dissolves the binder resin in the toner particle, but can dissolve fumaric acid contained near the surface of the toner. Therefore, f1 is an indicator of the content of fumaric acid contained near the surface of the toner. If the value of f1 falls within the range mentioned above, it is easier to form a blocking layer having high environmental stability.

The method for incorporating fumaric acid in the toner is not particularly limited, and any well-known method can be used. One example is to incorporate fumaric acid in the toner particle contained in the toner. That is, the toner particle preferably contains fumaric acid.

For example, in a case where the toner particle is produced using a pulverization method, it is possible to use a method comprising incorporating the fumaric acid in a raw material resin in advance or a method comprising adding the fumaric acid when the raw materials are melt kneaded so as to incorporate the fumaric acid in the toner particle.

In a case where the toner particle is produced using a wet production method such as a suspension polymerization method or an emulsion aggregation method, it is possible to use a method comprising incorporating the fumaric acid in a raw material or a method comprising adding the fumaric acid via an aqueous medium in the production process.

In addition, it is possible to use a method comprising externally adding the fumaric acid to the toner particle using a well-known external addition method.

Methods for producing components that constitute the toner and a method for producing the toner will now be explained in greater detail.

### Binder Resin

The toner particle contains a binder resin. For the binder resin, the following resins and polymers can be given as examples of polyester resins, vinyl-based resins, and other binder resins. Examples thereof include styrene acrylic resins, polyester resins, epoxy resins, polyurethane resins, polyamide resins, cellulose resins, polyether resins, and mixed resins and complex resins of these.

From the perspectives of being inexpensive and easy to procure and exhibiting excellent low-temperature fixability, the binder resin preferably contains a polyester resin, a styrene acrylic resin or a hybrid resin of these, and more preferably contains a polyester resin. It is more preferable for the binder resin to be a polyester resin.

The polyester resin can be obtained by using a conventional well-known method, such as a transesterification method or a polycondensation method, by selecting and combining appropriate materials from among polycarboxylic acids, polyols, hydroxycarboxylic acids, and the like.

A polycarboxylic acid is a compound having 2 or more carboxyl groups per molecule. Of these, a dicarboxylic acid is a compound having 2 carboxyl groups per molecule, and is preferably used.

Examples of dicarboxylic acids include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid and cyclohexanedicarboxylic acid.

Examples of polycarboxylic acids other than the dicarboxylic acids mentioned above include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid and n-octenylsuccinic acid. It is possible to use one of these polycarboxylic acids in isolation or a combination of two or more types thereof.

A polyol is a compound having 2 or more hydroxyl groups per molecule. Of these, a diol is a compound having 2 hydroxyl groups per molecule, and is preferably used.

Specific examples include ethylene glycol, diethylene glycol, triethylene glycol, 1,2-propylene glycol, 1,3-propylene glycol, 1,4-butane diol, 1,5-pentane diol, 1,6-hexane diol, 1,7-heptane diol, 1,8-octane diol, 1,9-nonane diol, 1,10-decane diol, 1,11-undecane diol, 1,12-dodecane diol, 1,13-tridecane diol, 1,14-tetradecane diol, 1,18-octadecane diol, 1,14-eicosane diol, dipropylene glycol, polyethylene glycol, polypropylene glycol, polytetramethylene ether glycol, 1,4-cyclohexane diol, 1,4-cyclohexane dimethanol, 1,4-butene diol, neopentyl glycol, 1,4-cyclohexane diol, polytetramethylene glycol, hydrogenated bisphenol A, bisphenol A, bisphenol F, bisphenol S, and alkylene oxide (ethylene oxide, propylene oxide, butylene oxide and the like) adducts of these bisphenol compounds.

Of these, alkylene glycols having 2 to 12 carbon atoms and alkylene oxide adducts of bisphenol compounds are preferred, and alkylene oxide adducts of bisphenol compounds and combinations of alkylene oxide adducts of bisphenol compounds and alkylene glycols having 2 to 12 carbon atoms are particularly preferred.

The binder resin is more preferably a condensation polymer of a monomer mixture containing an alkylene glycol having 2 to 12 carbon atoms, an alkylene oxide adduct of bisphenol A (in which the average number of added moles is preferably 1 to 5), and terephthalic acid. The binder resin is preferably an amorphous polyester resin.

Examples of trihydric or higher polyols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac and alkylene oxide adducts of the trihydric or higher polyphenol compounds listed above. It is possible to use one of these trihydric or higher polyols in isolation or a combination of two or more types thereof. In addition, the polyester resin may be a urea group-containing polyester resin. The polyester resin is preferably one in which a carboxyl group at a terminal or the like is not capped.

Examples of styrene acrylic resins include homopolymers comprising polymerizable monomers listed below, copolymers obtained by combining two or more of these polymerizable monomers, and mixtures of these.

Styrene-based monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; (meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, (meth)acrylic acid and maleic acid;

Vinyl ether-based monomers such as vinyl methyl ether and vinyl isobutyl ether; and vinyl ketone-based monomers such as vinyl methyl ketone, vinyl ethyl ketone and vinyl isopropenyl ketone; Polyolefins of ethylene, propylene, butadiene, and the like.

The styrene acrylic resin can be obtained using a polyfunctional polymerizable monomer if necessary. Examples of polyfunctional polymerizable monomers include diethylene glycol di(meth)acrylate, triethylene glycol di(meth)acrylate, tetraethylene glycol di(meth)acrylate, polyethylene glycol di(meth)acrylate, 1,6-hexane diol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolpropane tetra(meth)acrylate, divinylbenzene, divinylnaphthalene and divinyl ether.

In addition, it is possible to further add well-known chain transfer agents and polymerization inhibitors in order to control the degree of polymerization.

Examples of polymerization initiators used for obtaining the styrene acrylic resin include organic peroxide-based initiators and azo-based polymerization initiators.

Examples of organic peroxide-based initiators include benzoyl peroxide, lauroyl peroxide, di-α-cumyl peroxide, 2,5-dimethyl-2,5-bis(benzoyl peroxy)hexane, bis(4-t-butylcyclohexyl) peroxydicarbonate, 1,1-bis(t-butyl peroxy)cyclododecane, t-butyl peroxymaleic acid, bis(t-butyl peroxy)isophthalate, methyl ethyl ketone peroxide, tert-butyl peroxy-2-ethylhexanoate, diisopropyl peroxycarbonate, cumene hydroperoxide, 2,4-dichlorobenzoyl peroxide and tert-butyl-peroxypivalate.

Examples of azo type initiators include 2,2′-azobis(2,4-dimethylvaleronitrile), 2,2′-azobisisobutyronitrile, 1,1′-azobis(cyclohexane-1-carbontrile), 2,2′-azobis-4-methoxy-2,4-dimethylvaleronitrile, azobis(methylbutyronitrile) and 2,2′-azobis-(methylisobutyrate).

In addition, a redox type initiator obtained by combining an oxidizing substance with a reducing substance can be used as a polymerization initiator.

Examples of oxidizing substances include inorganic peroxides such as hydrogen peroxide and persulfates (sodium salts, potassium salts and ammonium salts), and oxidizing metal salts such as tetravalent cerium salts.

Examples of reducing substances include reducing metal salts (divalent iron salts, monovalent copper salts and trivalent chromium salts), ammonia, amino compounds such as lower amines (amines having from 1 to 6 carbon atoms, such as methylamine and ethylamine) and hydroxylamine, reducing sulfur compounds such as sodium thiosulfate, sodium hydrosulfite, sodium hydrogen sulfite, sodium sulfite and aldehyde sulfoxylates, lower alcohols (having from 1 to 6 carbon atoms), ascorbic acid and salts thereof, and lower aldehydes (having from 1 to 6 carbon atoms).

The polymerization initiator is selected with reference to 10-hour half-life decomposition temperatures, and can be a single polymerization initiator or a mixture thereof. The added amount of polymerization initiator varies according to the target degree of polymerization, but is generally an amount of from 0.5 parts by mass to 20.0 parts by mass relative to 100.0 parts by mass of polymerizable monomer.

The binder resin may contain a crystalline polyester. Examples of the crystalline polyester include condensation polymerization products of aliphatic diols and aliphatic dicarboxylic acids.

The crystalline polyester resin is preferably a condensation polymerization product of an aliphatic diol having from 2 to 12 carbon atoms and an aliphatic dicarboxylic acid having from 2 to 12 carbon atoms as primary components. Examples of aliphatic diols having from 2 to 12 carbon atoms include the compounds listed below. 1,2-ethane diol, 1,3-propane diol, 1,4-butane diol, 1,5-pentane diol, 1,6-hexane diol, 1,7-heptane diol, 1,8-octane diol, 1,9-nonane diol, 1,10-decane diol, 1,11-undecane diol, 1,12-dodecane diol, and the like.

In addition, an aliphatic diol having a double bond can be used. Examples of aliphatic diols having a double bond include the compounds listed below. 2-butene-1,4-diol, 3-hexene-1,6-diol and 4-octene-1,8-diol.

Examples of aliphatic dicarboxylic acids having from 2 to 12 carbon atoms include the compounds listed below. Oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, and lower alkyl esters and acid anhydrides of these aliphatic dicarboxylic acids.

Of these, sebacic acid, adipic acid, 1,10-decanedicarboxylic acid, and lower alkyl esters and acid anhydrides of these are preferred. It is possible to use one of these aliphatic polycarboxylic acids in isolation, or a mixture of two or more types thereof.

In addition, an aromatic dicarboxylic acid can be used. Examples of aromatic dicarboxylic acids include the compounds listed below. Terephthalic acid, isophthalic acid, 2,6-naphthalenedicarboxylic acid and 4,4′-biphenyldicarboxylic acid. Of these, terephthalic acid is preferred from perspectives such as ease of procurement and ease of forming a low melting point polymer.

In addition, a dicarboxylic acid having a double bond can be used. A dicarboxylic acid having a double bond can crosslink the entire resin by means of the double bond, and can be advantageously used in order to suppress hot offsetting at the time of fixing.

Examples of such dicarboxylic acids include fumaric acid, maleic acid, 3-hexene dioic acid and 3-octene dioic acid. In addition, lower alkyl esters and acid anhydrides of these can also be used. Of these, fumaric acid and maleic acid are more preferred.

The method for producing the crystalline polyester is not particularly limited, and it is possible to produce the crystalline polyester by means of an ordinary polyester polymerization method in which a dicarboxylic acid component is reacted with a diol component. For example, it is possible to use a direct polycondensation method or a transesterification method, and the crystalline polyester can be produced using either of these methods depending on the type of monomer used.

The content of the crystalline polyester is preferably from 1.0 parts by mass to 30.0 parts by mass, and more preferably from 3.0 parts by mass to 25.0 parts by mass, relative to 100 parts by mass of the binder resin.

The peak temperature of the maximum endothermic peak of the crystalline polyester, as measured using a differential scanning calorimeter (DSC), is preferably from 50.0° C. to 100.0° C., and is more preferably from 60.0° C. to 90.0° C. from the perspective of low-temperature fixability.

The molecular weight of the binder resin is such that the peak molecular weight Mp is preferably from 5000 to 100000, and more preferably from 10000 to 40000. The weight average molecular weight Mw is preferably 4000 to 20000, and more preferably 5000 to 10000.

The glass transition temperature Tg of the binder resin is preferably from 40° C. to 70° C., and more preferably from 40° C. to 60° C. In addition, the acid value of the binder resin is preferably 1.0 to 30.0 mg KOH/g, and more preferably 5.0 to 20.0 mg KOH/g.

### Crosslinking Agent

To control the molecular weight of the binder resin constituting the toner particle, a crosslinking agent may also be added during polymerization of the polymerizable monomers.

Examples include ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinyl benzene, bis(4-acryloxypolyethoxyphenyl) propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400 and #600, dipropylene glycol diacrylate, polypropylene glycol diacrylate, polyester diacrylate (MANDA, Nippon Kayaku Co., Ltd.), and these with methacrylate substituted for the acrylate.

The added amount of the crosslinking agent is preferably from 0.001 to 15.000 mass parts per 100 mass parts of the polymerizable monomers.

### Release Agent

A well-known wax can be used as a release agent in the toner.

Specific examples thereof include petroleum-based waxes and derivatives thereof, such as paraffin waxes, microcrystalline waxes and petrolatum, montan wax and derivatives thereof, hydrocarbon waxes and derivatives thereof obtained using the Fischer Tropsch process, polyolefin waxes and derivatives thereof, such as polyethylene waxes and polypropylene waxes, and natural waxes and derivatives thereof, such as carnauba wax and candelilla wax. Derivatives include oxides, block copolymers formed with vinyl monomers, and graft-modified products.

Further examples include higher aliphatic alcohols; fatty acids, such as stearic acid and palmitic acid, and amides, esters and ketones of these acids; hydrogenated castor oil and derivatives thereof, plant waxes and animal waxes. It is possible to use one of these release agents in isolation, or a combination thereof.

Of these, use of a polyolefin, a hydrocarbon wax produced using the Fischer Tropsch process or a petroleum-based wax is preferred from the perspectives of developing performance and transferability being improved. Moreover, antioxidants may be added to these waxes as long as the characteristics of the toner are not adversely affected.

In addition, from the perspectives of phase separation from the binder resin and crystallization temperature, preferred examples include higher fatty acid esters such as behenyl behenate and dibehenyl sebacate. In addition, an ester wax can also be advantageously used as the plasticizer described later.

The content of the release agent is preferably from 1.0 parts by mass to 30.0 parts by mass relative to 100.0 parts by mass of the binder resin.

The melting point of the release agent is preferably from 30° C. to 120° C., and more preferably from 60° C. to 100° C. By using a release agent having a melting point of from 30° C. to 120° C., a releasing effect is efficiently achieved and a broader fixing range is ensured.

### Plasticizer

A crystalline plasticizer is preferably used in order to improve the sharp melt properties of the toner. The plasticizer is not particularly limited, and well-known plasticizers used in toners, such as those listed below, can be used.

Examples thereof include esters of monohydric alcohols and aliphatic carboxylic acids and esters of monohydric carboxylic acids and aliphatic alcohols, such as behenyl behenate, stearyl stearate and palmityl palmitate; esters of dihydric alcohols and aliphatic carboxylic acids and esters of dihydric carboxylic acids and aliphatic alcohols, such as ethylene glycol distearate, dibehenyl sebacate and hexane diol dibehenate; esters of trihydric alcohols and aliphatic carboxylic acids and esters of trihydric carboxylic acids and aliphatic alcohols, such as glycerin tribehenate; esters of tetrahydric alcohols and aliphatic carboxylic acids and esters of tetrahydric carboxylic acids and aliphatic alcohols, such as pentaerythritol tetrastearate and pentaerythritol tetrapalmitate; esters of hexahydric alcohols and aliphatic carboxylic acids and esters of hexahydric carboxylic acids and aliphatic alcohols, such as dipentaerythritol hexastearate and dipentaerythritol hexapalmitate; esters of polyhydric alcohols and aliphatic carboxylic acids and esters of polycarboxylic acids and aliphatic alcohols, such as polyglycerol behenate; and natural ester waxes such as carnauba wax and rice wax. It is possible to use one of these plasticizers in isolation, or a combination thereof.

### Colorant

The toner particle may contain a colorant. A well-known pigment or dye can be used as the colorant. From the perspective of excellent weathering resistance, a pigment is preferred as the colorant.

Examples of cyan colorants include copper phthalocyanine compounds and derivatives thereof, anthraquinone compounds and basic dye lake compounds.

Specific examples thereof include the following. C.I. Pigment Blue 1, 7, 15, 15:1, 15:2, 15:3, 15:4, 60, 62 and 66.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds and perylene compounds.

Specific examples thereof include the following. C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221 and 254, and C.I. Pigment Violet 19.

Examples of yellow colorants include condensed azo compounds, isoindolinone compounds, anthraquinone compounds, azo metal complexes, methine compounds and allylamide compounds.

Specific examples thereof include the following. C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191 and 194.

Examples of black colorants include carbon black and materials colored black using the yellow colorants, magenta colorants and cyan colorants mentioned above.

It is possible to use one of these colorants in isolation, or a combination thereof, and these can be used in the form of solid solutions.

The content of the colorant is preferably from 1.0 parts by mass to 20.0 parts by mass relative to 100.0 parts by mass of the binder resin.

### Charge Control Agent and Charge Control Resin

The toner particle may contain a charge control agent or a charge control resin. A well-known charge control agent can be used, and a charge control agent which has a fast triboelectric charging speed and can stably maintain a certain triboelectric charge quantity is particularly preferred. Furthermore, in a case where a toner particle is produced using a suspension polymerization method, a charge control agent which exhibits low polymerization inhibition properties and which is substantially insoluble in an aqueous medium is particularly preferred.

Examples of charge control agents that impart the toner particle with negative chargeability include monoazo metal compounds, acetylacetone metal compounds, aromatic oxycarboxylic acid, aromatic dicarboxylic acid, oxycarboxylic acid and dicarboxylic acid-based metal compounds, aromatic oxycarboxylic acids, aromatic mono- and poly-carboxylic acids and metal salts, anhydrides and esters thereof, phenol derivatives such as bisphenol, urea derivatives, metal-containing salicylic acid-based compounds, metal-containing naphthoic acid-based compounds, boron compounds, quaternary ammonium salts, calixarenes and charge control resins.

It is possible to use a polymer or copolymer having a sulfonic acid group, a sulfonic acid salt group or a sulfonic acid ester group as the charge control resin. It is particularly preferable for a polymer having a sulfonic acid group, a sulfonic acid salt group or a sulfonic acid ester group to contain a sulfonic acid group-containing acrylamide-based monomer or a sulfonic acid group-containing methacrylamide-based monomer at a copolymerization ratio of 2 mass % or more, and more preferably 5 mass % or more.

The charge control resin preferably has a glass transition temperature (Tg) of from 35° C. to 90° C., a peak molecular weight (Mp) of from 10000 to 30000, and a weight average molecular weight (Mw) of from 25000 to 50000. In a case where this is used, it is possible to impart preferred triboelectric charging characteristics without adversely affecting thermal characteristics required of the toner particle. Furthermore, if the charge control resin contains a sulfonic acid group, dispersibility of the charge control resin per se in the polymerizable monomer composition and dispersibility of the colorant and the like are improved, and tinting strength, transparency and triboelectric charging characteristics can be further improved.

It is possible to add one of these charge control agents or charge control resins in isolation, or a combination of two or more types thereof.

The added amount of the charge control agent or charge control resin is preferably from 0.01 parts by mass to 20.0 parts by mass, and more preferably from 0.5 parts by mass to 10.0 parts by mass, relative to 100.0 parts by mass of the binder resin.

### Toner Particle Production Method

The toner particle preferably has a core particle that contains the binder resin and a shell on the surface of the core particle. The method for producing the toner particle is not particularly limited, and can be a well-known method, and it is possible to use a kneading pulverization method or a wet production method. A wet production method is preferred from the perspectives of particle diameter uniformity and shape control properties and readily obtaining a toner particle which has a core-shell structure. Examples of wet production methods include suspension polymerization methods, dissolution suspension methods, emulsion polymerizations and emulsion aggregation methods, and an emulsion aggregation method is more preferred from the perspective of facilitating control of the shape of the toner particle. That is, the toner particle is preferably obtained by means of emulsion aggregation.

In an emulsion aggregation method, dispersed solutions of materials such as fine particles of the binder resin and the colorant are first prepared. If necessary, dispersion stabilizers are added to the obtained dispersed solutions of these materials, and dispersed and mixed. Next, a flocculant is added so as to aggregate the dispersed solutions to a desired toner particle diameter, and resin fine particles are fused to each other during or after the aggregation. Toner particles are then formed by carrying out shape control using heat if necessary.

The toner production method preferably has the following steps:
(1) a dispersion and mixing step for preparing a binder resin fine particle-dispersed solution containing the binder resin and fumaric acid (if necessary, a colorant fine particle-dispersed solution or the like) and mixing to obtain a mixed dispersed solution,
(2) an aggregation step for aggregating binder resin fine particles (if necessary, colorant fine particles and the like) contained in the mixed dispersed solution so as to form aggregates, and
(3) a fusion step for heating and fusing the aggregates to form fused particles.

The toner particle can be obtained by cooling the obtained fused particles.

In addition, the toner production method more preferably has the following steps (4) and (5) in that order after step (3):
(4) an annealing step for heating and holding the fused particles at a temperature that is not lower than the crystallization temperature or glass transition temperature of the binder resin, and
(5) a cooling step for cooling the fused particles at a cooling rate of 0.1° C./see or more to obtain the toner particle.

Here, fine particles of the binder resin can form composite particles formed from a plurality of layers comprising two or more layers of resins having different compositions. For example, the toner particle can be produced using an emulsion polymerization method, a mini-emulsion polymerization method, a phase inversion emulsification method, or the like, or by combining several of these methods. In a case where the toner particle contains an internal additive, the internal additive may be contained in resin fine particles, or is possible to separately prepare an internal additive fine particle-dispersed solution comprising only the internal additive and then carry out aggregation when the internal additive fine particles are aggregated with the resin fine particles. In addition, it is possible to carry out aggregation by adding resin fine particles having different compositions at different times during aggregation, thereby producing a toner particle having a configuration in which layers have different compositions. It is possible to aggregate resin fine particles containing the binder resin so as to form a core part and then carry out aggregation by adding resin fine particles containing the resin for shell-forming at different times so as to form a shell part.

The shell-forming resin may be the same as, or different from, the binder resin. For example, fumaric acid can be incorporated in the shell-forming resin. Resin fine particles that contain the shell-forming resin may contain fumaric acid. The added amount of the shell-forming resin (the shell content) is preferably 1.0 to 10.0 parts by mass, and more preferably 2.0 to 7.0 parts by mass, relative to 100 parts by mass of the binder resin contained in the core particles.

In this case, the toner production method preferably has the following steps:
(1) a dispersion and mixing step for preparing a binder resin fine particle-dispersed solution containing the binder resin and fumaric acid (if necessary, a colorant fine particle-dispersed solution or the like) and mixing to obtain a mixed dispersed solution,
(2) an aggregation step for aggregating binder resin fine particles (if necessary, colorant fine particles and the like) contained in the mixed dispersed solution so as to form aggregates,
(3) a shell formation step for further adding resin fine particles containing a shell-forming resin to the dispersed solution containing the aggregates, causing the resin fine particles to aggregate, and forming aggregates having a shell, and
(4) a fusion step for heating and fusing the aggregates to form fused particles.

In addition, the toner production method preferably has step (5) below either during step (4) or after steps (1) to (4):
(5) a heat sphering step for heating the aggregates by further increasing the temperature.

In addition, the toner production method more preferably has the following steps (6) and (7) in that order after step (5):
(6) an annealing step for heating and holding the fused particles at a temperature that is not lower than the crystallization temperature or glass transition temperature of the binder resin, and
(7) a cooling step for cooling the fused particles at a cooling rate of 0.1° C./see or more to obtain the toner particle.

The added amount of fumaric acid is preferably 0.006 to 0.500 parts by mass, more preferably 0.006 to 0.400 parts by mass, and further preferably 0.010 to 0.200 parts by mass, relative to 100 parts by mass of the binder resin. By setting this added amount to fall within the range mentioned above, it is easier to favorably adjust the content of fumaric acid in the toner.

Substances listed below can be used as dispersion stabilizers.

Well-known cationic surfactants, anionic surfactants and non-ionic surfactants can be used as surfactants.

Examples of inorganic dispersion stabilizers include tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica and alumina. In addition, examples of organic dispersion stabilizers include poly(vinyl alcohol), gelatin, methyl cellulose, methylhydroxypropyl cellulose, ethyl cellulose, sodium carboxymethyl cellulose and starch.

In addition to surfactants having the opposite polarity from surfactants used in the dispersion stabilizers mentioned above, inorganic salts and divalent or higher inorganic metal salts can be advantageously used as flocculants. Inorganic metal salts are particularly preferred from the perspectives of facilitating control of aggregation properties and toner charging performance due to polyvalent metal elements being ionized in aqueous media.

Specific examples of preferred inorganic metal salts include metal salts such as calcium chloride, calcium nitrate, barium chloride, magnesium chloride, zinc chloride, iron chloride, aluminum chloride and aluminum sulfate; and inorganic metal salt polymers such as iron polychloride, aluminum polychloride, aluminum polyhydroxide and calcium polysulfide. Of these, aluminum salts and polymers thereof are particularly preferred. In order to attain a sharper particle size distribution, it is generally preferable for the valency of an inorganic metal salt to be divalent rather than monovalent and trivalent or higher rather than divalent, and an inorganic metal salt polymer is more suitable for a given valency.

From the perspectives of high image precision and resolution, the weight-average particle diameter (D4) of the toner particles is preferably from 3.0 μm to 10.0 μm. In addition, from the perspective of achieving a balance between developing performance, transferability and cleaning performance, the average circularity of the toner particle is preferably from 0.95 to 0.98.

### Toner Production Method

The toner contains the hydrotalcite particles as the external additive. If necessary, other external additives may be added. Examples of other external additives include inorganic oxide fine particles such as silica fine particles, alumina fine particles, titanium oxide fine particles, and the like; fine particles of inorganic stearic acid compounds, such as aluminum stearate fine particles and zinc stearate fine particles; and fine particles of inorganic titanate compounds such as strontium titanate and zinc titanate. It is possible to use one of these external additives in isolation or a combination of two or more types thereof. The external additives preferably further contain silica particles.

These inorganic fine particles are preferably subjected to a gloss treatment using a silane coupling agent, a titanium coupling agent, a higher fatty acid, a silicone oil, or the like in order to improve heat-resistant storability and improve environmental stability. The BET specific surface area of an external additive is preferably from 10 m²/g to 450 m²/g.

The BET specific surface area can be determined by means of a low temperature gas adsorption method using a dynamic constant pressure method in accordance with a BET method (and preferably a BET multipoint method). For example, BET specific surface area (m²/g) can be calculated by causing nitrogen gas to adsorb to the surface of a sample using a specific surface area measurement apparatus (a Gemini 2375 Ver. 5.0 produced by Shimadzu Corporation) and carrying out measurements using a BET multipoint method.

The total added amount of these external additives is preferably from 0.05 parts by mass to 5 parts by mass, and more preferably from 0.1 parts by mass to 3 parts by mass, relative to 100 parts by mass of toner particles. In addition, a combination of various external additives may be used.

The mixing machine used for externally adding the external additive to the toner particle is not particularly limited, and it is possible to use a well-known mixing machine regardless of whether this is a wet mixer or a dry mixer. Examples thereof include an FM mixer (available from Nippon Coke and Engineering Co., Ltd.), a super mixer (available from Kawata Co., Ltd.), a Nobilta (available from Hosokawa Micron Corp.) or a Hybridizer (available from Nara Machinery Co., Ltd.). It is possible to prepare the toner by adjusting the speed of rotation of the external addition apparatus, the treatment time, the jacket water temperature or the amount of water in order to control the state of coverage of the external additive.

In addition, examples of classifying apparatuses able to be used for sieving out coarse particles following the external addition include an Ultrasonic (available from Koei Sangyo Co., Ltd.); a Rezona Sieve or Gyro Sifter (available from Tokuju Co., Ltd.); a Vibrasonic System (available from Dalton); a Soniclean (available from Sinto Kogyo); a Turbo Screener (available from Turbo Kogyo); and a Micron Sifter (available from Makino Mfg. Co., Ltd.).

The toner is preferably used in a process cartridge or electrophotographic image forming apparatus having a cleaning member such as a cleaning blade. This type of process cartridge or electrophotographic image forming apparatus can be a well-known product.

For example, a process cartridge is preferably a process cartridge which can be attached to, and detached from, an electrophotographic image forming apparatus. In addition, the process cartridge preferably comprises: a latent image bearing member; a developing means for developing an electrostatic latent image on the outer surface of the latent image bearing member using a toner; and a cleaning blade for removing toner on the outer surface of the latent image bearing member following the development, and the toner is preferably the toner described above.

In addition, the electrophotographic image forming apparatus preferably comprises, for example: a latent image bearing member; a developing means for developing an electrostatic latent image on the outer surface of the latent image bearing member using a toner; and a cleaning blade for removing toner on the outer surface of the latent image bearing member following the development. The toner is preferably the toner described above.

Explanations will now be given of methods for measuring physical properties of the toner and materials.

### Method for Identifying Hydrotalcite Particles

Hydrotalcite particles, which are an external additive, can be identified by combining shape observations obtained using a scanning electron microscope (SEM) with elemental analysis using energy dispersive X-Ray analysis (EDS).

The toner is observed in a field of view magnified a maximum of 50,000 times using a S-4800 scanning electron microscope (produced by Hitachi, Ltd.). The microscope is focused on the toner particle surface, and the external additive to be identified is observed. It is possible to perform EDS analysis on the external additive to be identified and identify hydrotalcite particles from types of element peaks.

For the elemental peaks, if the elemental peak of at least one metal selected from the group consisting of the metals Mg, Zn, Ca, Ba, Ni, Sr, Cu and Fe that may constitute the hydrotalcite particle and the elemental peak of at least one metal selected from the group consisting of Al, B, Ga, Fe, Co and In are observed, the presence of a hydrotalcite particle containing these two metals can be deduced.

A standard sample of the hydrotalcite particle deduced from EDS analysis is prepared separately, and subjected to EDS analysis and SEM shape observation. A particle to be distinguished can be judged to be a hydrotalcite particle based on whether the analysis results for the standard sample match the analysis results for the particle to be distinguished.

### Method for Measuring Content a (%) of Hydrotalcite Particles in Toner on a Mass Basis

The content a (%) of the hydrotalcite particles in the toner on a mass basis can be quantitatively determined by X-Ray fluorescence analysis using a calibration curve prepared from a standard sample. Fluorescence X-Ray measurements of elements are carried out in accordance with JIS K 0119-1969, but are specifically carried out in the following way.

A wavelength-dispersive X-Ray fluorescence analysis apparatus (Axios produced by PANalytical) is used as the measurement apparatus, and dedicated software for this apparatus (SuperQ ver. 4.0F produced by PANalytical) is used in order to set measurement conditions and analyze measured data. Moreover, Rh is used as the X-Ray bulb anode, the measurement atmosphere is a vacuum, the measurement diameter (collimator mask diameter) is 27 mm, and the measurement time is 10 seconds. In addition, detection is carried out using a proportional counter (PC) in cases where light elements are measured, and detection is carried out using a scintillation counter (SC) in cases where heavy elements are measured.

4 g of toner is placed as a measurement sample in a dedicated aluminum ring for pressing, leveled off, pressurized for 60 seconds at a pressure of 20 MPa using a tablet compression molder, and molded into a pellet having a thickness of 2 mm and a diameter of 39 mm. The tablet compression molder is a “BRE-32” produced by Maekawa Testing Machine MFG. Co., Ltd.

Measurements are carried out under the conditions described above, elements are identified on the basis of obtained X-Ray peak positions, and concentrations are calculated from count rates (units: cps), which are the number of X-Ray photons per unit time.

0.10 parts by mass of separately prepared standard hydrotalcite particles is added to 100 parts by mass of toner particles and thoroughly mixed using a coffee mill. Similarly, hydrotalcite particles are mixed at quantities of 0.20 parts by mass and 0.50 parts by mass with toner particles, and these are used as samples for a calibration curve.

Using these samples, count rates (units: cps) derived from metallic elements in the hydrotalcite are measured. In this case, the accelerating voltage of the X-Ray generator is 24 kV, and the current is 100 mA. A linear function calibration curve is obtained by using the obtained X-Ray count rate as the vertical axis and the added amount of hydrotalcite fine particles in the calibration curve samples as the horizontal axis.

Next, a toner to be analyzed is formed as a pellet in the manner described above using a tablet compression molder, and count rates derived from metallic elements in the hydrotalcite are measured. The content a (%) of hydrotalcite particles in the toner on a mass basis is determined from this calibration curve.

Method for Measuring Element Ratios in Hydrotalcite Particles Element ratios in hydrotalcite particles are measured by means of EDS mapping measurements of the toner using a scanning transmission electron microscope (STEM). In the EDS mapping measurements, each pixel in an analysis area has spectral data. By using a silicon drift detector having a large detection element area, EDS mapping measurements can be carried out with high sensitivity.

By performing statistical analysis on spectral data of pixels obtained using the EDS mapping measurements, it is possible to obtain primary component mapping in which pixels with similar spectra are extracted, and mapping of specific components is possible.

An observation sample is prepared using the following procedure.

A cylindrical toner pellet having a diameter of 8 mm and a thickness of approximately 1 mm is produced by weighing out 0.5 g of a toner and leaving to stand for 2 minutes under a load of 40 kN using a Newton Press in a cylindrical mold having a diameter of 8 mm. A flake having a thickness of 200 nm is produced from the toner pellet using an ultramicrotome (FC7 produced by Leica).

STEM-EDS mapping analysis is carried out using the following apparatus and conditions.
Scanning transmission electron microscope: JEM-2800 produced by JEOL Ltd.
EDS detector: JED-2300T produced by JEOL Ltd.; dry SD100GV detector (detection element area: 100 mm²)
EDS analyzer: NORAN System 7 produced by Thermo Fisher Scientific

### STEM-EDS Conditions

STEM accelerating voltage: 200 kV
Magnification ratio: 20,000 times
Probe size: 1 nm
STEM image size: 1024×1024 pixels (EDS elemental mapping images are obtained at the same location)
EDS mapping size: 256×256 pixels, dwell time: 30 μs, number of accumulations: 100 frames

Calculations of element ratios in hydrotalcite particles are determined in the following way on the basis of multivariate analysis.

EDS mapping is obtained using the STEM-EDS analysis apparatus mentioned above. Next, acquired spectral mapping data is subjected to multivariate analysis using COMPASS (PCA) mode in the measurement command section of the NORAN System 7 mentioned above, and a primary component mapping image is extracted.

Preset values in this process are as follows.
Kernel size: 3×3
Quantification mapping setting: high (slow)
Filter fit type: high precision (slow)

The areal ratios of the extracted primary components in the EDS measurement field of view are calculated at the same time using this procedure. Obtained EDS spectra in the primary component mapping is subjected to quantitative analysis using the Cliff-Lorimer method.

A toner particle portion and a hydrotalcite particle are differentiated on the basis of the quantitative analysis results of the obtained STEM-EDS primary component mapping. Said particle can be identified as a hydrotalcite particle from the particle size, the particle shape, the content of polyvalent metals such as aluminum and magnesium, and the quantity ratio thereof.

In addition, it is also possible to determine whether fluorine and aluminum are present in the inner part of the hydrotalcite particle by the means described below.

Method for Analyzing Fluorine and Aluminum in Hydrotalcite Particles Fluorine and aluminum in the hydrotalcite particles are analyzed on the basis of mapping data derived from STEM-EDS mapping analysis obtained using the method described above. Specifically, fluorine and aluminum present in the inner part of the particle are analyzed by carrying out EDS line analysis in a normal direction relative to the periphery of the hydrotalcite particle.

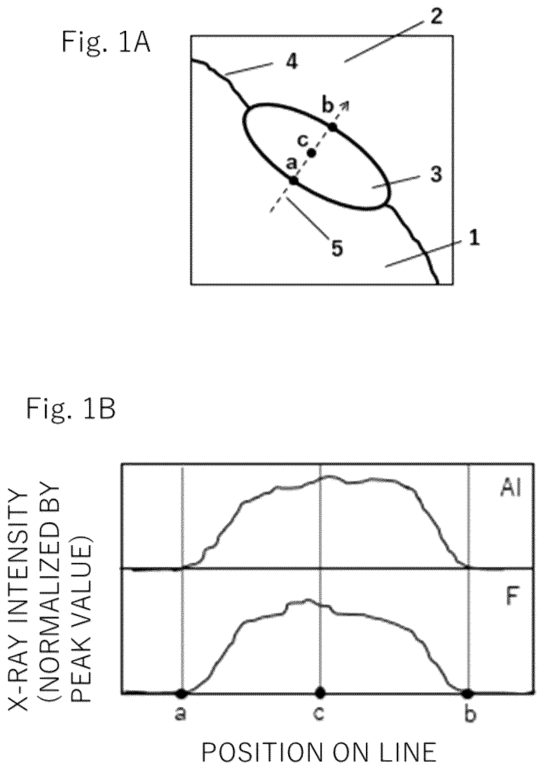

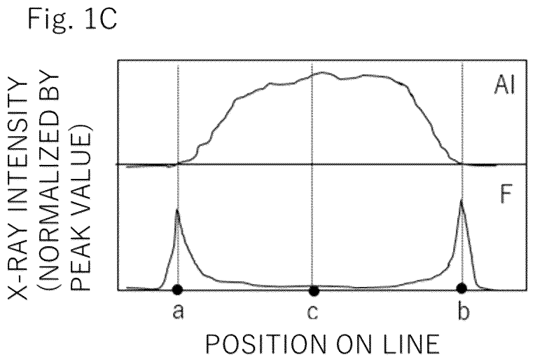

FIG. 1A shows a schematic diagram of line analysis. For a hydrotalcite particle 3 adjacent to a toner particle 1 and a toner particle 2, line analysis is carried out in a normal direction relative to the periphery of the hydrotalcite particle 3, that is, in the direction of the arrow on the dotted line 5. Moreover, 4 indicates the boundary between the toner particles.

An area in which a hydrotalcite particle is present in the acquired STEM image is selected using a rectangular selection tool, and line analysis is carried out using the following conditions.

### Line Analysis Conditions

STEM magnification ratio: 800,000 times
Line length: 200 nm
Line width: 30 nm
Number of line divisions: 100 (intensity measured every 2 nm)

In a case where the element peak intensity of fluorine or aluminum is at least 1.5 times the background intensity in an EDS spectrum of a hydrotalcite particle, and in a case where the element peak intensity of fluorine or aluminum at both edges of a hydrotalcite particle (points a and b in FIG. 1A) in the line analysis is not more than 3.0 times the peak intensity at point c, it is assessed that the element in question is contained in the inner part of the hydrotalcite particle. Moreover, point c is the midpoint on the line a-b (that is, the midpoint between both edges of the particle).

Examples of X-Ray intensities of fluorine and aluminum obtained using line analysis are shown in FIG. 1B and FIG. 1C. In a case where the inner part of a hydrotalcite particle contains fluorine and aluminum, a graph of X-Ray intensity normalized by peak intensity has a shape such as that shown in FIG. 1B. In a case where a hydrotalcite particle contains fluorine derived from a surface treatment agent, a graph of X-Ray intensity normalized by peak intensity has peaks in the vicinity of the edges a and b in the graph for fluorine, as shown in FIG. 1C. By confirming X-Ray intensities derived from fluorine and aluminum in the line analysis, it is possible to confirm that the inner part of the hydrotalcite particle contains fluorine and aluminum.

### Method for Calculating Concentration Ratio of Number of Fluorine Atoms Relative to Aluminum Atoms (F/Al Element Ratio) in the Hydrotalcite Particles

The concentration ratio of the number of fluorine atoms relative to aluminum atoms (F/Al) in the hydrotalcite particles, as determined by primary component mapping derived from hydrotalcite particles in the STEM-EDS mapping analysis described above, is acquired for multiple fields of view, and by determining the arithmetic mean value for 100 or more of said particles, the concentration ratio of the number of fluorine atoms relative to aluminum atoms (F/Al) in the hydrotalcite particles is determined.

### Method for Calculating Concentration Ratio of Number of Magnesium Atoms Relative to Aluminum Atoms (Mg/Al Element Ratio) in Hydrotalcite Particles

The concentration ratio of the number of magnesium atoms relative to aluminum atoms (Mg/Al element ratio) in hydrotalcite particles is calculated using a method similar to the method described above for calculating the concentration ratio of the number of fluorine atoms relative to aluminum atoms (F/Al) in hydrotalcite particles.

### Method for Measuring Number Average Particle Diameter of Primary Particles of Hydrotalcite Particles

The number average particle diameter of the hydrotalcite particles is measured by combining elemental analysis obtained from an “S-4800” scanning electron microscope (produced by Hitachi, Ltd.) with energy dispersive X-Ray analysis (EDS). A toner to which the external additive has been externally added is observed, and the hydrotalcite particles are photographed in a field of view at a maximum magnification rate of 200,000 times. Hydrotalcite particles are selected from photographed images, the lengths of primary particles of 100 hydrotalcite particles selected at random are measured, and the number average particle diameter is determined. The magnification ratio is adjusted as appropriate according to the size of the external additive. Here, particles able to be seen as single particles in observations are assessed as being primary particles.

### Method for Measuring Content b (%) of Fumaric Acid in Toner on a Mass Basis

0.1 g of a toner is dissolved in 1 mL of chloroform. 20 mL of methanol is added dropwise to be obtained sample solution, resin content in the solution is precipitated, and solid components are removed by carrying out centrifugal separation (10 minutes at 12000 rpm using a HITACHI himac CR22G). The solvent is distilled off from the obtained solution under reduced pressure, and drying is then carried out for 4 hours under reduced pressure in an atmosphere at 60° C. 0.5 mL of BSTFA (N,O-bis(trimethylsilyl)trifluoroacetamide and 0.5 mL of acetonitrile are added to the obtained sample, and a silylation treatment is carried out by heating for 1 hour at 80° C. The obtained sample is analyzed using GC-MS (gas chromatography-mass spectrometry).

Specific measurement conditions are as follows.
GCMS apparatus: Trace 1310 (produced by Thermo Fisher Scientific), ISQ (produced by Thermo Fisher Scientific)
Column: HP-5 ms [30 m]
Injection port temperature: 250° C., injected amount: 1 μL
Column oven temperature: 40° C.→300° C. (15° C./min)
MS ionization mode: EI
Ion source temperature: 250° C.
Mass range: 35 to 800 m/z
A profile obtained from this analysis is analyzed, peak positions of measurement samples are compared with peak positions in a profile obtained from a fumaric acid standard substance, and the presence/absence of fumaric acid is determined by confirming the mass spectrum.

Meanwhile, several samples are prepared by weighing out only a fumaric acid standard substance (for example, 100 ng, 200 ng and 300 ng), measurements are carried out under the conditions described above before carrying out measurements on the samples obtained from the toner, and a calibration curve is prepared from charged amounts of fumaric acid and fumaric acid peak areas.

The content b (%) of fumaric acid in the toner is determined by converting the area of fumaric acid components in the toner into the mass of fumaric acid on the basis of this calibration curve, and then converting into an amount based on the mass of the toner.

Method for Measuring Content f1 (Mass %) on a Mass Basis in Toner of Fumaric Acid Extracted from Toner Using Methanol

0.5 g of toner is placed in 20 mL of methanol and dispersed for 30 minutes. Solid components are then removed by carrying out centrifugal separation (10 minutes at 12000 rpm using a HITACHI himac CR22G). The solvent is distilled off from the obtained solution under reduced pressure, and drying is then carried out for 4 hours under reduced pressure in an atmosphere at 60° C. 0.5 mL of BSTFA (N,O-bis(trimethylsilyl)trifluoroacetamide and 0.5 mL of acetonitrile are added to the obtained sample, and a silylation treatment is carried out by heating for 1 hour at 80° C. The obtained sample is analyzed using GC-MS (gas chromatography-mass spectrometry).

Specific measurement conditions are as follows.
GCMS apparatus: Trace 1310 (produced by Thermo Fisher Scientific), ISQ (produced by Thermo Fisher Scientific)
Column: HP-5 ms [30 m]
Injection port temperature: 250° C.
Injected amount: 1 μL
Column oven temperature: 40° C.→300° C. (15° C./min)
MS ionization mode: EI
Ion source temperature: 250° C.
Mass range: 35 to 800 m/z

A profile obtained from this analysis is analyzed, peak positions of measurement samples are compared with peak positions in a profile obtained from a fumaric acid standard substance, and the presence/absence of fumaric acid is determined by confirming the mass spectrum.

Meanwhile, several samples are prepared by weighing out only a fumaric acid standard substance (for example, 100 ng, 200 ng and 300 ng), measurements are carried out under the conditions described above before carrying out measurements on the samples, and a calibration curve is prepared from charged amounts of fumaric acid and fumaric acid peak areas.

The content f1 (mass %) on a mass basis in the toner of fumaric acid, which is extracted from toner using methanol, is determined by converting the area of fumaric acid components in the sample into the mass of fumaric acid on the basis of this calibration curve, and then converting into an amount based on the mass of the toner.

### Methods for Measuring Peak Molecular Weight (Mp) and Weight Average Molecular Weight (Mw)

The peak molecular weight (Mp) and weight average molecular weight (Mw) of the crystalline materials, the resins, the toner, and so on, are measured using gel permeation chromatography (GPC), in the manner described below. First, a sample to be measured is dissolved in tetrahydrofuran (THF) at room temperature. If the sample is difficult to dissolve, the sample is heated at a temperature of 35° C. or lower. A sample solution is then obtained by filtering the obtained solution using a solvent-resistant membrane filter having a pore diameter of 0.2 μm (a “Mishoridisk” produced by Tosoh Corporation). Moreover, the sample solution is adjusted so that the concentration of THF-soluble components is 0.8 mass %. Measurements are carried out using this sample solution under the following conditions.
Apparatus: High speed GPC apparatus (HLC-8220GPC produced by Tosoh Corporation)
Column: Two LF-604 connected in series (produced by Showa Denko Kabushiki Kaisha)
Eluant: THF
Flow rate: 0.6 mL/min
Oven temperature: 40° C.
Injected amount: 0.020 mL

When calculating the molecular weight of the sample, a molecular weight calibration curve is prepared using standard polystyrene resins (product names “TSK Standard Polystyrene F-850, F-450, F-288, F-128, F-80, F-40, F-20, F-10, F-4, F-2, F-1, A-5000, A-2500, A-1000 and A-500”, produced by Tosoh Corporation).

### Method for Measuring Acid Value of Binder Resin and so on

Acid value is the amount (mg) of potassium hydroxide required to neutralize acid contained in 1 g of a sample. Acid value is measured in accordance with JIS K 0070-1992, but is specifically measured using the following procedure.

### (1) Reagent Preparation

A phenolphthalein solution is obtained by dissolving 1.0 g of phenolphthalein in 90 mL of ethyl alcohol (95 vol. %) and adding ion exchanged water up to a volume of 100 mL.

7 g of special grade potassium hydroxide is dissolved in 5 mL of water, and ethyl alcohol (95 vol. %) is added up to a total volume of 1 L. A potassium hydroxide solution is obtained by placing the obtained solution in an alkali-resistant container so as not to be in contact with carbon dioxide gas or the like, allowing solution to stand for 3 days, and then filtering. The obtained potassium hydroxide solution is stored in the alkali-resistant container. The factor of the potassium hydroxide solution is determined by placing 25 mL of 0.1 mol/L hydrochloric acid in a conical flask, adding several drops of the phenolphthalein solution, titrating with the potassium hydroxide solution, and determining the factor from the amount of the potassium hydroxide solution required for neutralization. The 0.1 mol/L hydrochloric acid is produced in accordance with JIS K 8001-1998.

### (2) Operation

### (A) Main Test

2.0 g of a pulverized binder resin sample is measured precisely into a 200 mL conical flask, 100 mL of a mixed toluene/ethanol (2:1) solution is added, and the sample is dissolved over a period of 5 hours. Next, several drops of the phenolphthalein solution are added as an indicator, and titration is carried out using the potassium hydroxide solution. Moreover, the endpoint of the titration is deemed to be the point when the pale crimson color of the indicator is maintained for approximately 30 seconds.

### (B) Blank Test

Titration is carried out in the same way as in the operation described above, except that the sample is not used (that is, only a mixed toluene/ethanol (2:1) solution is used).

(3) The Acid Value is Calculated by Inputting the Obtained Results into the Formula Below.

$$A = [ ( C - B ) \times f \times 5.61 ] / S$$

Here, A denotes the acid value (mg KOH/g), B denotes the added amount (mL) of the potassium hydroxide solution in the blank test, C denotes the added amount (mL) of the potassium hydroxide solution in the main test, f denotes the factor of the potassium hydroxide solution, and S denotes the mass (g) of the sample.

### Method for Measuring Melting Point

The melting point of crystalline materials (crystalline resins or waxes) is measured under the following conditions using a differential scanning calorimeter (DSC) (Q2000 produced by TA Instruments).
Temperature increase rate: 10° C./min
Measurement start temperature: 20° C.
Measurement end temperature: 180° C.

Temperature calibration of the detector in the apparatus is performed using the melting points of indium and zinc, and heat amount calibration is performed using the heat of fusion of indium. Specifically, 5 mg of a sample is weighed out, placed in an aluminum pan, and one measurement is carried out. An empty aluminum pan is used as a reference. Here, the peak temperature of the maximum endothermic peak is taken to be the melting point.

### Measurement of Glass Transition Temperature (Tg)

The glass transition temperature of an amorphous resin is the temperature (° C.) at a point on a temperature-increasing reversing heat flow curve, which is obtained by means of differential scanning calorimetric measurements in the melting point measurement method described above, where a straight line at an equal distance in the vertical axis direction from a straight line obtained by extending the baseline before and after a change in specific heat intersects with a curve of a part where glass transition changes in a stepwise manner on the reversing heat flow curve.

### Method for Measuring Weight Average Particle Diameter (D4) of Toner

The weight average particle diameter (D4) of toner is calculated as follows. A “Multisizer 3 Coulter Counter” precise particle size distribution analyzer (registered trademark, Beckman Coulter, Inc.) based on the pore electrical resistance method and equipped with a 100 μm aperture tube is used as the measurement unit together with the accessory dedicated “Beckman Coulter Multisizer 3 Version 3.51” software (Beckman Coulter, Inc.) for setting the measurement conditions and analyzing the measurement data. Measurement is performed with 25,000 effective measurement channels.

The aqueous electrolytic solution used in measurement may be a solution of special grade sodium chloride dissolved in ion-exchanged water to a concentration of about 1 mass %, such as “ISOTON II” (Beckman Coulter, Inc.) for example.

The following settings are performed on the dedicated software prior to measurement and analysis.

On the “Change standard measurement method (SOMME)” screen of the dedicated software, the total count number in control mode is set to 50000 particles, the number of measurements to 1, and the Kd value to a value obtained with “Standard particles 10.0 μm” (Beckman Coulter, Inc.). The threshold and noise level are set automatically by pushing the “Threshold/noise level measurement” button. The current is set to 1600 μA, the gain to 2, and the electrolytic solution to ISOTON II, and a check is entered for “Aperture tube flush after measurement”.

On the “Conversion settings from pulse to particle diameter” screen of the dedicated software, the bin interval is set to the logarithmic particle diameter, the particle diameter bins to 256, and the particle diameter range to 2 to 60 μm.

The specific measurement methods are as follows.
(1) About 200 mL of the aqueous electrolytic solution is placed in a glass 250 mL round-bottomed beaker dedicated to the Multisizer 3, the beaker is set on the sample stand, and stirring is performed with a stirrer rod counter-clockwise at a rate of 24 rps. Contamination and bubbles in the aperture tube are then removed by the “Aperture tube flush” function of the dedicated software.
(2) 30 mL of the same aqueous electrolytic solution is placed in a glass 100 mL flat-bottomed beaker, and about 0.3 mL of a dilution of “Contaminon N” (a 10 mass % aqueous solution of a pH⁷ neutral detergent for washing precision instruments, comprising a nonionic surfactant, an anionic surfactant, and an organic builder, manufactured by Wako Pure Chemical Industries, Ltd.) diluted about three times by mass with ion-exchange water is added.
(3) An ultrasonic disperser “Ultrasonic Dispersion Systern Tetra150” (Nikkaki Bios Co., Ltd.) with an electrical output of 120 W equipped with two built-in oscillators having an oscillating frequency of 50 kHz with their phases shifted by 180° from each other is prepared. About 3.3 L of ion-exchange water is added to the water tank of the ultrasonic disperser, and about 2 mL of Contaminon N is added to the tank.
(4) The beaker of (2) above is set in the beaker-fixing hole of the ultrasonic disperser, and the ultrasonic disperser is operated. The height position of the beaker is adjusted so as to maximize the resonant condition of the liquid surface of the aqueous electrolytic solution in the beaker.
(5) The aqueous electrolytic solution in the beaker of (4) above is exposed to ultrasound as about 10 mg of toner is added bit by bit to the aqueous electrolytic solution, and dispersed. Ultrasound dispersion is then continued for a further 60 seconds. During ultrasound dispersion, the water temperature in the tank is adjusted appropriately to from 10° C. to 40° C.
(6) The aqueous electrolytic solution of (5) above with the toner dispersed therein is dripped with a pipette into the round-bottomed beaker of (1) above set on the sample stand, and adjusted to a measurement concentration of about 5%. Measurement is then performed until the number of measured particles reaches 50000.
(7) The weight average particle diameter (D4) is calculated by analyzing measurement data using the accompanying dedicated software. Moreover, when setting the graph/vol. % with the dedicated software, the “average diameter” on the “Analysis/volume-based statistical values (arithmetic mean)” screen is weight-average particle diameter (D4).

### Method for Measuring Average Circularity

The average circularity of the toner particle is measured when carrying out calibration work using a flow particle image analyzer (a “FPIA-3000” available from Sysmex Corporation), and measured under analysis conditions.

The specific measurement method is as follows. First, approximately 20 mL of ion exchanged water from which solid impurities and the like have been removed in advance is placed in a glass container. Approximately 0.2 mL of a diluted liquid, which is obtained by diluting “Contaminon N” (a 10 mass % aqueous solution of a neutral detergent for cleaning precision measurement equipment, which has a pH of 7 and comprises a non-ionic surfactant, an anionic surfactant and an organic builder, available from Wako Pure Chemical Industries, Ltd.) approximately 3-fold with deionized water, is added to the beaker as a dispersant. Next, approximately 0.02 g of a measurement sample is added and dispersed for 2 minutes using an ultrasonic disperser so as to obtain a dispersed solution for measurement. At this point, the dispersed solution is cooled as appropriate to a temperature of from 10° C. to 40° C. A tabletop ultrasonic cleaning disperser having an oscillation frequency of 50 kHz and an electrical output of 150 W (for example, a “VS-150” available from Velvo-Clear) is used as the ultrasonic disperser, a prescribed amount of ion exchanged water is added to a water tank, and approximately 2 mL of Contaminon N is added to the water tank.

Measurements are carried out using the flow particle image analyzer fitted with a “UPlanApo” as an object lens (10 times magnification; numerical aperture 0.40), and particle sheath “PSE-900A” (produced by Sysmex Corporation) is used as the sheath liquid. A dispersed solution prepared on the basis of this procedure is introduced into the flow particle image analyzer, and 3000 toner particles are measured in HPF measurement mode and total count mode. In addition, the average circularity of the toner is determined by setting the binary threshold value to 85% when analyzing the particles and limiting the diameters of analyzed particles to circle-equivalent diameters of not less than 1.985 μm and less than 39.69 μm.

When carrying out the measurements, automatic focus adjustment is carried out prior to the start of measurements using standard latex particles (for example, particles obtained by diluting “RESEARCH AND TEST PARTICLES Latex Microsphere Suspensions 5200A” available from Duke Scientific with ion exchanged water). Thereafter, it is preferable to carry out focus adjustment every 2 hours from the start of measurements.

A flow particle image analyzer that had been calibrated by Sysmex Corporation and issued a calibration certificate by Sysmex Corporation was used in working examples in the present application. Other than limiting the diameters of analyzed particles to circle-equivalent diameters of not less than 1.985 μm and less than 39.69 μm, measurements were carried out under measurement and analysis conditions when the calibration certification was issued.

### EXAMPLES

The present invention will now be explained in greater detail by means of the following working examples and comparative examples, but is in no way limited to these examples. Numbers of “parts” used in the working examples mean parts by mass unless explicitly indicated otherwise.

Production examples of the toner will now be explained.

### Production Example of Polyester Resin 1

1.0 parts by mole of terephthalic acid, 0.65 parts by mole of an adduct of 2 moles of propylene oxide to bisphenol A and 0.35 parts by mole of ethylene glycol were added to a reaction vessel equipped with a stirring machine, a temperature gauge, a nitrogen inlet tube, a dewatering tube and a depressurization device, and heated to a temperature of 130° C. while being stirred. Next, tin di(2-ethylhexanoate) was added as an esterification catalyst at an amount of 0.52 parts relative to a total of 100.0 parts of the monomers mentioned above, and the temperature was then increased to 200° C., and condensation polymerization was carried out until a prescribed molecular weight was reached. Next, 0.03 parts by mole of trimellitic anhydride was added, a reaction was continued for 1 hour, and amorphous polyester resin 1 was obtained. The obtained polyester resin 1 had a weight average molecular weight (Mw) of 6000, a glass transition temperature (Tg) of 49° C., and an acid value of 11.2 mg KOH/g.

### Production Example of Polyester Resin 2

Fumaric acid: 24.61 parts (50.0 mol %)
Adduct of 2.2 moles of propylene oxide to bisphenol A: 75.39 parts (50.0 mol %)
Dibutyl tin oxide: 0.5 parts
Hydroquinone: 0.05 parts

The materials listed above were charged in an autoclave equipped with a depressurization device, a water separation device, a nitrogen gas inlet device, a temperature measurement device and a stirrer, and a reaction was carried out at 230° C. until the degree of conversion reached 90%, after which a reaction was carried out for 1 hour at a reduced pressure of 60 to 70 mm Hg to obtain amorphous polyester resin 2. In the present specification, the term “degree of conversion” means amount of water generated in reaction (mol)/theoretical amount of water generated (mol)×100.

The obtained polyester resin 2 had an acid value of 20.3 mg KOH/g, a weight average molecular weight (Mw) of 14000 and a glass transition temperature of 59.6° C.

### Production Example of Polyester Resin 3

1,6-hexane diol: 48.96 parts (50.0 mol %)
Fumaric acid: 36.10 parts (37.5 mol %)
Adipic acid: 14.94 parts (12.5 mol %)
Dibutyl tin oxide: 0.1 parts
Hydroquinone: 0.05 parts

The materials listed above were charged in an autoclave equipped with a depressurization device, a water separation device, a nitrogen gas inlet device, a temperature measurement device and a stirrer, a reaction was carried out for 5 hours at 160° C. in a nitrogen atmosphere, the temperature was then increased to 200° C., and a reaction was carried out for 1 hour. A reaction was carried out for a further 1 hour at a reduced pressure of 60 to 70 mm Hg to obtain polyester resin 3, which was a crystalline polyester.

### Production Example of Binder Resin 1

Polyester monomers were mixed at the proportions shown below.
Cyclohexanedicarboxylic acid: 0.650 moles
Hexanedioic acid: 0.200 moles
Adipic acid: 0.100 moles
Dodecenyl succinic acid anhydride: 0.050 moles
Fumaric acid: 0.008 moles
Cyclohexanedimethanol: 0.690 moles
Propylene glycol: 0.300 moles
Ethylene glycol: 0.090 moles

0.1 mass % of tetrabutyl titanate as a catalyst and 0.01 mass % of magnesium acetate as a co-catalyst were added to the materials listed above, and condensation polymerization was carried out at 240° C. to obtain an unsaturated polyester resin (Tg=53° C.; main peak molecular weight=5800).

75 parts by mass of this unsaturated polyester resin, 18 parts by mass of styrene and 6.5 parts by mass of n-butyl acrylate as vinyl monomers, 0.5 parts by mass of mono-n-butyl maleate, 2 parts by weight of a paraffin wax (Mn 450, Mw 520, main peak molecular weight 500, DSC peak temperature 75.0° C.) and 0.08 parts by mass of 2,5-dimethyl-2,5-bis(t-butylperoxy)hexane-3 (10-hour half-life temperature 128° C.) as an initiator were mixed. This vinyl monomer/polyester resin mixture was polymerized at 120° C. for 20 hours until the vinyl monomer polymerization rate was 98%, after which the temperature was increased to 150° C. and maintained for 5 hours so as to polymerize unreacted vinyl monomers and obtain binder resin 1.

### Preparation of Polyester Resin Particle-Dispersed Solution 1

Polyester resin 1: 200 parts
Ion exchanged water: 500 parts
Fumaric acid: 0.170 parts

The materials listed above were placed in a stainless steel container, melted by being heated to 95° C. using a warm bath, and 0.1 mol/L sodium bicarbonate was added while vigorously stirring at 7800 rpm using a homogenizer (an Ultratarax T50 produced by IKA) to increase the pH to more than 7.0. Next, a mixed solution of 3 parts of sodium dodecylbenzene sulfonate and 297 parts of ion exchanged water was gradually added dropwise, emulsified and dispersed to obtain polyester resin particle-dispersed solution 1.

When the particle size distribution of polyester resin particle-dispersed solution 1 was measured using a particle size measurement apparatus (LA-960V2 produced by Horiba, Ltd.), the number average particle diameter of polyester resin particles was 0.25 μm, and coarse particles having sizes of more than 1 μm were not observed.

Preparation of Polyester Resin Particle-Dispersed Solutions 2 to 11 Polyester resin particle-dispersed solutions 2 to 11 were obtained in the same way as in the production example of polyester resin particle-dispersed solution 1, except that the added amount of fumaric acid was changed to an amount shown in Table 1.

TABLE 1

| | Added amount |
|---|---|
| | (parts by mass) |
| | of fumaric |
| | acid |
| Polyester resin particle-dispersed solution 1 | 0.170 |
| Polyester resin particle-dispersed solution 2 | 0.120 |
| Polyester resin particle-dispersed solution 3 | 0.010 |
| Polyester resin particle-dispersed solution 4 | 0.007 |
| Polyester resin particle-dispersed solution 5 | 0.024 |
| Polyester resin particle-dispersed solution 6 | 0.250 |
| Polyester resin particle-dispersed solution 7 | 0.010 |
| Polyester resin particle-dispersed solution 8 | 0.220 |
| Polyester resin particle-dispersed solution 9 | 0.012 |
| Polyester resin particle-dispersed solution 10 | 0.290 |
| Polyester resin particle-dispersed solution 11 | 0.310 |

### Preparation of Polyester Resin Particle-Dispersed Solution 12

Polyester resin 1: 200 parts
Ion exchanged water: 500 parts

The materials listed above were placed in a stainless steel container, melted by being heated to 95° C. using a warm bath, and 0.1 mol/L sodium bicarbonate was added while vigorously stirring at 7800 rpm using a homogenizer (an Ultratarax T50 produced by IKA) to increase the pH to more than 7.0. Next, a mixed solution of 3 parts of sodium dodecylbenzene sulfonate and 297 parts of ion exchanged water was gradually added dropwise, emulsified and dispersed to obtain polyester resin particle-dispersed solution 12.

When the particle size distribution of polyester resin particle-dispersed solution 12 was measured using a particle size measurement apparatus (LA-960V2 produced by Horiba, Ltd.), the number average particle diameter of polyester resin particles was 0.25 μm, and coarse particles having sizes of more than 1 μm were not observed.

### Preparation of Polyester Resin Particle-Dispersed Solution 13

Polyester resin 2: 200 parts
Ion exchanged water: 500 parts

The materials listed above were placed in a stainless steel container, melted by being heated to 95° C. using a warm bath, and 0.1 mol/L sodium bicarbonate was added while vigorously stirring at 7800 rpm using a homogenizer (an Ultratarax T50 produced by IKA) to increase the pH to more than 7.0. Next, a mixed solution of 3 parts of sodium dodecylbenzene sulfonate and 297 parts of ion exchanged water was gradually added dropwise, emulsified and dispersed to obtain polyester resin particle-dispersed solution 13.

When the particle size distribution of polyester resin particle-dispersed solution 13 was measured using a particle size measurement apparatus (LA-960V2 produced by Horiba, Ltd.), the number average particle diameter of polyester resin particles was 0.25 μm, and coarse particles having sizes of more than 1 μm were not observed.

### Preparation of Polyester Resin Particle-Dispersed Solution 14

Polyester resin 1: 200 parts
Ion exchanged water: 500 parts
Phthalic acid: 0.170 parts

The materials listed above were placed in a stainless steel container, melted by being heated to 95° C. using a warm bath, and 0.1 mol/L sodium bicarbonate was added while vigorously stirring at 7800 rpm using a homogenizer (an Ultratarax T50 produced by IKA) to increase the pH to more than 7.0. Next, a mixed solution of 3 parts of sodium dodecylbenzene sulfonate and 297 parts of ion exchanged water was gradually added dropwise, emulsified and dispersed to obtain polyester resin particle-dispersed solution 14.

When the particle size distribution of polyester resin particle-dispersed solution 14 was measured using a particle size measurement apparatus (LA-960V2 produced by Horiba, Ltd.), the number average particle diameter of polyester resin particles was 0.25 μm, and coarse particles having sizes of more than 1 μm were not observed.

### Preparation of Polyester Resin Particle-Dispersed Solution 15

Polyester resin 1: 200 parts
Ion exchanged water: 500 parts
Maleic acid: 0.170 parts

The materials listed above were placed in a stainless steel container, melted by being heated to 95° C. using a warm bath, and 0.1 mol/L sodium bicarbonate was added while vigorously stirring at 7800 rpm using a homogenizer (an Ultratarax T50 produced by IKA) to increase the pH to more than 7.0. Next, a mixed solution of 3 parts of sodium dodecylbenzene sulfonate and 297 parts of ion exchanged water was gradually added dropwise, emulsified and dispersed to obtain polyester resin particle-dispersed solution 15.

When the particle size distribution of polyester resin particle-dispersed solution 15 was measured using a particle size measurement apparatus (LA-960V2 produced by Horiba, Ltd.), the number average particle diameter of polyester resin particles was 0.25 μm, and coarse particles having sizes of more than 1 μm were not observed.

### Preparation of Polyester Resin Particle-Dispersed Solution 16

Polyester resin 1: 160 parts
Polyester resin 3: 40 parts
Ion exchanged water: 500 parts

The materials listed above were placed in a stainless steel container, melted by being heated to 95° C. using a warm bath, and 0.1 mol/L sodium bicarbonate was added while vigorously stirring at 7800 rpm using a homogenizer (an Ultratarax T50 produced by IKA) to increase the pH to more than 7.0. Next, a mixed solution of 3 parts of sodium dodecylbenzene sulfonate and 297 parts of ion exchanged water was gradually added dropwise, emulsified and dispersed to obtain polyester resin particle-dispersed solution 16.

When the particle size distribution of polyester resin particle-dispersed solution 16 was measured using a particle size measurement apparatus (LA-960V2 produced by Horiba, Ltd.), the number average particle diameter of polyester resin particles was 0.25 μm, and coarse particles having sizes of more than 1 μm were not observed.

### Preparation Example of Resin Particle-Dispersed Solution 17

Binder resin 1: 200 parts
Ion exchanged water: 500 parts

The materials listed above were placed in a stainless steel container, melted by being heated to 95° C. using a warm bath, and 0.1 mol/L sodium bicarbonate was added while vigorously stirring at 7800 rpm using a homogenizer (an Ultratarax T50 produced by IKA) to increase the pH to more than 7.0. Next, a mixed solution of 3 parts of sodium dodecylbenzene sulfonate and 297 parts of ion exchanged water was gradually added dropwise, emulsified and dispersed to obtain resin particle-dispersed solution 17.

When the particle size distribution of resin particle-dispersed solution 17 was measured using a particle size measurement apparatus (LA-960V2 produced by Horiba, Ltd.), the number average particle diameter of resin particles was 0.25 μm, and coarse particles having sizes of more than 1 μm were not observed.

### Preparation Example of Wax Particle-Dispersed Solution

Ion exchanged water: 500 parts
Wax (hydrocarbon wax; temperature of maximum endothermic peak: 77° C.): 250 parts

The materials listed above were placed in a stainless steel container, melted by being heated to 95° C. using a warm bath, and 0.1 mol/L sodium bicarbonate was added while vigorously stirring at 7800 rpm using a homogenizer (an Ultratarax T50 produced by IKA) to increase the pH to more than 7.0.

Next, a mixed solution of 5 parts of sodium dodecylbenzene sulfonate and 245 parts of ion exchanged water was gradually added dropwise, emulsified and dispersed. When the particle size distribution of wax particles in the wax particle-dispersed solution was measured using a particle size measurement apparatus (LA-960V2 produced by Horiba, Ltd.), the number average particle diameter of contained wax particles was 0.35 μm, and coarse particles having sizes of more than 1 μm were not observed.

### Preparation Example of Colorant Particle-Dispersed Solution

Carbon black: 100 parts
Sodium dodecylbenzene sulfonate: 5 parts
Ion exchanged water: 400 parts

The materials listed above were mixed and dispersed using a sand grinding mill to obtain a colorant particle-dispersed solution. When the particle size distribution of colorant particles in the colorant particle-dispersed solution was measured using a particle size measurement apparatus (LA-960V2 produced by Horiba, Ltd.), the number average particle diameter of contained colorant particles was 0.2 μm, and coarse particles having sizes of more than 1 μm were not observed.

### Production Example of Toner Particle 1

Polyester resin particle-dispersed solution 1: 500 parts
Colorant particle-dispersed solution: 50 parts
Wax particle-dispersed solution: 50 parts
Sodium dodecylbenzene sulfonate: 5 parts

The polyester resin particle-dispersed solution 1, the wax particle-dispersed solution and the sodium dodecylbenzene sulfonate were placed in a reactor (a 1 L flask equipped with an anchor blade having a baffle) and homogeneously mixed. Meanwhile, a mixed dispersed solution was obtained by homogeneously mixing the colorant particle-dispersed solution in a 500 mL beaker and then gradually adding this to the reactor while stirring. Aggregated particles were formed by adding 0.5 parts (in terms of solid content) of an aqueous solution of aluminum sulfate dropwise while stirring the obtained mixed dispersed solution.

Following completion of the dropwise addition, the system was purged with nitrogen and then held for 1 hour at 50° C. and then for 1 hour at 55° C. The temperature was then increased to 90° C. and held for 30 minutes. Fused particles were then formed by lowering the temperature to 63° C. and maintaining this temperature for 3 hours. At this point, the reaction was carried out in a nitrogen atmosphere. After a prescribed period of time, the system was cooled to room temperature at a temperature decrease rate of 0.5° C./min.

Following this cooling, the reaction product was subjected to solid-liquid separation at a pressure of 0.4 MPa using a pressure filter having a capacity of 10 L, thereby obtaining a toner cake. The pressure filter was then filled with ion exchanged water, and the toner cake was washed at a pressure of 0.4 MPa. Washing was carried out in the same way a total of three times. Solid-liquid separation was then carried out at a pressure of 0.4 MPa and fluidized bed drying was carried out at 45° C. to obtain toner particle 1, which had a weight-average particle diameter (D4) of 6.8 μm and an average circularity of 0.97.

### Production Examples of Toner Particle 2 to 16

Toner particles 2 to 16 were obtained in the same way as in the production example of toner 1, except that polyester resin particle-dispersed solution 1 was replaced by polyester resin particle-dispersed solutions 2 to 16. Physical properties of the obtained toner particle are shown in Table 2.

### Production Example of Toner Particle 17

Toner particle 17 was obtained in the same way as in the production example of toner 1, except that polyester resin particle-dispersed solution 1 was replaced by resin particle-dispersed solution 17. Physical properties of obtained toner particle 17 are shown in Table 2.

TABLE 2

| | | Weight | |
|---|---|---|---|
| | | average | |
| | Polyester resin | particle | |
| | particle-dispersed | diameter | Average |
| | solution No. | D4 μm | circularity |
| Toner particle 1 | 1 | 6.8 | 0.97 |
| Toner particle 2 | 2 | 6.8 | 0.97 |
| Toner particle 3 | 3 | 6.7 | 0.96 |
| Toner particle 4 | 4 | 7.0 | 0.97 |
| Toner particle 5 | 5 | 6.8 | 0.98 |
| Toner particle 6 | 6 | 7.1 | 0.97 |
| Toner particle 7 | 7 | 6.5 | 0.96 |
| Toner particle 8 | 8 | 6.9 | 0.95 |
| Toner particle 9 | 9 | 7.2 | 0.96 |
| Toner particle 10 | 10 | 6.8 | 0.96 |
| Toner particle 11 | 11 | 6.8 | 0.96 |
| Toner particle 12 | 12 | 6.8 | 0.96 |
| Toner particle 13 | 13 | 6.9 | 0.96 |
| Toner particle 14 | 14 | 7.0 | 0.96 |
| Toner particle 15 | 15 | 6.6 | 0.97 |
| Toner particle 16 | 16 | 6.8 | 0.97 |
| Toner particle 17 | 17 | 6.8 | 0.97 |

Moreover, a dispersed solution used in toner particle 17 is resin particle-dispersed solution 17.

### Production Example of Hydrotalcite Particles 1

Hydrotalcite particles 1 were produced in the manner described below.

A mixed aqueous solution (solution A) containing 1.03 mol/L of magnesium chloride and 0.239 mol/L of aluminum sulfate, an aqueous solution containing 0.753 mol/L of sodium carbonate (solution B) and an aqueous solution containing 3.39 mol/L of sodium hydroxide (solution C) were prepared.

Next, solution A, solution B and solution C were injected into a reaction tank at a solution A: solution B volume ratio of 4.5:1 using metering pumps, the pH of the reaction liquid was held between the range 9.3 to 9.6 using solution C, and a reaction was carried out at a temperature of 40° C. to produce a precipitate. The precipitate was filtered, washed and re-emulsified with ion exchanged water to obtain a raw material hydrotalcite slurry. The concentration of hydrotalcite in the obtained hydrotalcite slurry was 5.6 mass %.

The obtained hydrotalcite slurry was dried overnight at 40° C. A solution was prepared by dissolving NaF in ion exchanged water at a concentration of 100 mg/L and adjusting the pH to 7.0 using 1 mol/L HCl or 1 mol/L NaOH, and the dried hydrotalcite was added to this solution at a concentration of 0.1% (w/v %). Using a magnetic stirrer, stirring was carried out at a fixed speed for 48 hours so that precipitation did not occur. The solution was then filtered using a membrane filter having a pore diameter of 0.5 μm, and then washed with ion exchanged water. The obtained hydrotalcite was dried overnight at 40° C. and then deagglomerated. The composition and physical properties of the obtained hydrotalcite particles 1 are shown in Table 3.

### Production Example of Hydrotalcite Particles 2 to 11

Hydrotalcite particles 2 to 11 were obtained in the same way as in the production example of hydrotalcite particles 1, except that the concentrations of solution A, solution B and the aqueous solution of NaF were conveniently adjusted. The composition and physical properties of the obtained hydrotalcite particles 2 to 11 are shown in Table 3.

### Production Example of Hydrotalcite Particles 12

Hydrotalcite particles 12 were obtained in the same way as in the production example of hydrotalcite particles 1, except that ion exchanged water was used instead of an aqueous solution of NaF. The composition and physical properties of the obtained hydrotalcite particles 12 are shown in Table 3.

TABLE 3

| | | | Number |
|---|---|---|---|
| | | | average |
| | | | particle |
| | Mg/Al | F/Al | diameter |
| | Ratio | Ratio | (nm) |
| Hydrotalcite particles 1 | 2.2 | 0.12 | 400 |
| Hydrotalcite particles 2 | 3.8 | 0.12 | 400 |
| Hydrotalcite particles 3 | 3.0 | 0.12 | 60 |
| Hydrotalcite particles 4 | 2.1 | 0.11 | 800 |
| Hydrotalcite particles 5 | 2.1 | 0.11 | 1000 |
| Hydrotalcite particles 6 | 3.8 | 0.10 | 1200 |
| Hydrotalcite particles 7 | 2.1 | 0.01 | 400 |
| Hydrotalcite particles 8 | 2.1 | 0.02 | 400 |
| Hydrotalcite particles 9 | 2.1 | 0.32 | 400 |
| Hydrotalcite particles 10 | 2.1 | 0.60 | 400 |
| Hydrotalcite particles 11 | 2.1 | 0.68 | 400 |
| Hydrotalcite particles 12 | 2.1 | 0.00 | 400 |

Number average particle diameter indicates the number average primary particle diameter.

### Production Example of Toner 1

(0.3 parts of) hydrotalcite particles 1 and (1.5 parts of) silica particles 1 (RX200; average primary particle diameter 12 nm; treated with HMDS; produced by Nippon Aerosil Co., Ltd.) were externally added and mixed with (100.0 parts of) the obtained toner particles 1 using a FM10C (produced by Nippon Coke and Engineering Co., Ltd.). External addition conditions were such that the lower blade was an A0 blade, the distance from the deflector wall was 20 mm, the charged amount of toner particles was 2.0 kg, the speed of rotation was 66.6 s⁻¹, the external addition time was 10 minutes, the temperature of cooling water was 20° C., and the flow rate of cooling water was 10 L/min.

Toner 1 was obtained by sieving through a mesh having an opening size of 200 μm. Physical properties of obtained toner 1 are shown in Table 4.

### Production Examples of Toners 2 to 27

Toners 2 to 27 were obtained in the same way as in the production example of toner 1, except that the type of toner particle and the type and added amount of hydrotalcite particles were altered as shown in Table 4. Physical properties of obtained toners 2 to 27 are shown in Table 4.

In toners 1 to 12 and 14 to 18, in which hydrotalcite particles 1 to 11 were used, fluorine and alumina were present in the inner part of the hydrotalcite particles, and it was confirmed that F/Al ratios were the same as in Table 3.

TABLE 4

| | | | Added amount | Hydrotalcite | Fumaric | | |
|---|---|---|---|---|---|---|---|
| | Toner | | (parts) of | particle | acid | | |
| Toner | particle | Hydrotalcite | hydrotalcite | content | content | | f1 |
| No. | No. | particle No. | particles | a (%) | b (%) | a/b | (%) |
| 1 | 1 | 1 | 0.30 | 0.29 | 0.070 | 4.1 | 0.0049 |
| 2 | 1 | 2 | 0.30 | 0.29 | 0.070 | 4.1 | 0.0049 |
| 3 | 2 | 1 | 0.05 | 0.05 | 0.050 | 1.0 | 0.0035 |
| 4 | 3 | 1 | 0.50 | 0.49 | 0.004 | 122.5 | 0.0003 |
| 5 | 4 | 1 | 0.50 | 0.49 | 0.003 | 163.3 | 0.0002 |
| 6 | 4 | 1 | 0.90 | 0.88 | 0.003 | 293.3 | 0.0002 |
| 7 | 5 | 3 | 0.30 | 0.29 | 0.015 | 19.3 | 0.0011 |
| 8 | 6 | 1 | 0.30 | 0.29 | 0.105 | 2.8 | 0.0074 |
| 9 | 7 | 4 | 0.30 | 0.29 | 0.004 | 72.5 | 0.0003 |
| 10 | 8 | 5 | 0.30 | 0.29 | 0.090 | 3.2 | 0.0063 |
| 11 | 9 | 6 | 0.30 | 0.29 | 0.005 | 58.0 | 0.0004 |
| 12 | 10 | 1 | 0.30 | 0.29 | 0.120 | 2.4 | 0.0084 |
| 13 | 1 | 12 | 0.30 | 0.29 | 0.070 | 4.1 | 0.0049 |
| 14 | 1 | 7 | 0.30 | 0.29 | 0.070 | 4.1 | 0.0049 |
| 15 | 1 | 8 | 0.30 | 0.29 | 0.070 | 4.1 | 0.0049 |
| 16 | 1 | 9 | 0.30 | 0.29 | 0.070 | 4.1 | 0.0049 |
| 17 | 1 | 10 | 0.30 | 0.29 | 0.070 | 4.1 | 0.0049 |
| 18 | 1 | 11 | 0.30 | 0.29 | 0.070 | 4.1 | 0.0049 |
| 19 | 1 | — | — | 0 | 0.070 | 0.0 | 0.0049 |
| 20 | 11 | 12 | 0.05 | 0.05 | 0.130 | 0.4 | 0.0091 |
| 21 | 12 | 12 | 0.30 | 0.29 | 0.000 | — | 0.0000 |
| 22 | 4 | 12 | 1.50 | 1.46 | 0.003 | 486.7 | 0.0002 |
| 23 | 13 | 12 | 0.30 | 0.29 | 0.000 | — | 0.0000 |
| 24 | 14 | 12 | 0.30 | 0.29 | 0.000 | — | 0.0000 |
| 25 | 15 | 12 | 0.30 | 0.29 | 0.000 | — | 0.0000 |
| 26 | 16 | 12 | 0.30 | 0.29 | 0.000 | — | 0.0000 |
| 27 | 17 | 12 | 0.30 | 0.29 | 0.000 | — | 0.0000 |

The following evaluations were carried out using the obtained toner.

### Image Evaluations

Image evaluations were carried out using a printer obtained by modifying parts of a commercially available color laser printer (a HP LaserJet Enterprise Color M555dn produced by HP). As a result of the modifications, the printer could be operated using only one color process cartridge. A toner was removed from a black cartridge and replaced by 100 g of a toner to be evaluated, which was then evaluated.

### Fogging

In order to test the charging performance of the toner, fogging in a low temperature low humidity environment (temperature: 10° C., relative humidity: 15%) (LL fogging) was evaluated using the method described below.

In a low temperature low humidity environment, a total of 2000 images were outputted at a print percentage of 1.0% at a rate of 1000/day, with an intermission time of 2 seconds every two images, on Canon Color Laser Copier paper (A4; 81.4 g/m², hereinafter this paper was used unless explicitly indicated otherwise). After the initial image and the 2000th image, fogging on the drum in the cartridge was collected by taping and evaluated.

The fogging was measured using a reflection densitometer (REFLECTOMETER MODEL TC-6DS produced by TOKYO DENSHOKU). The fogging density (%) was taken to be the value of (Ds−Dr), where Ds denotes the worst value of reflected density of white background parts of the tape section and Dr denotes the average value of reflected density of white background parts of the taped part of the paper. The fogging density was taken to be the worst value when measurements were carried out using three types of filter, namely green, amber and blue. In this evaluation method, fogging on the drum increases in cases where toner charging performance decreases.

Fogging density evaluations were assessed using the following criteria. An evaluation of C or better was assessed as being good.

### Evaluation Criteria

A: Fogging density of less than 0.5%
B: Fogging density of at least 0.5% and less than 1.5%
C: Fogging density of at least 1.5% and less than 3.0%
D: Fogging density of at least 3.0%

### Cleaning Performance

In order to test the cleaning performance of the toner, cleaning performance in a low temperature low humidity (LL) environment (temperature: 10° C., relative humidity: 15%) was evaluated using the method described below.

In a low temperature low humidity environment, a total of 2000 images having a print percentage of 1.0% were outputted at a rate of 1000 prints per day, with an intermission time of 2 seconds every 2 images. After the initial image and the 2000th image, three completely black images and one completely white image (a total of four images) were continuously outputted using the cartridge.

Next, cleaning performance following changes in temperature and humidity LL after HH) was evaluated using the procedure described below.

After outputting 2000 images in a low temperature low humidity environment, the cartridge was placed in a sealed plastic bag and allowed to stand for 1 hour in a high temperature high humidity environment (30° C., 80% humidity). The plastic bag was then opened and allowed to stand for a further 12 hours. The bag was then allowed to stand for 1 hour in a low temperature low humidity environment, and three completely black images and one completely white image (a total of four images) were continuously outputted in this environment.

In this evaluation, in a case where toner cleaning performance decreased, streak-like image defects (vertical black streaks) caused by faulty cleaning (toner slip-through) occurred in the completely white image outputted after the completely black images. Cleaning performance was assessed using the criteria below. An evaluation of C or better was assessed as being good.

### Evaluation Criteria

In a completely white image outputted after five completely black images,
A: No streak-like image defects were observed
B: 1 to 3 extremely small streak-like defects having widths of less than 1 mm were observed
C: 4 to 10 extremely small streak-like defects having widths of less than 1 mm were observed
D: 11 or more extremely small streak-like defects having widths of less than 1 mm were observed. Alternatively streak-like defects having widths of 1 mm or more were observed.

### Working Examples 1 to 18

In Working Examples 1 to 18, toners 1 to 18 were used as toners and subjected to the evaluations described above. The evaluation results are shown in Table 5.

TABLE 5

| | | | | | | Cleaning evaluation | | | | | | | | |
|---|---|---|---|---|---|---|---|---|---|---|---|---|---|---|
| | | | | | | LL initial | | | LL (after 2000 prints) | | | HH→LL (after 2000 prints) | | |
| | | | | | | | | Streaks | | | Streaks | | | Streaks |
| | | Fogging | | | | | | with | | | with | | | with |
| | | LL initial | | LL (after 2000 prints) | | | Extremely | widths | | Extremely | widths | | Extremely | widths |
| Exam- | | | Fog- | | Fog- | | small | of 1 mm | | small | of 1 mm | | small | of 1 mm |
| ple | Toner | | ging | | ging | | streaks | or more | | streaks | or more | | streaks | or more |
| No. | No. | Rank | % | Rank | % | Rank | (no.) | (no.) | Rank | (no.) | (no.) | Rank | (no.) | (no.) |
| 1 | 1 | A | 0.3 | A | 0.3 | A | 0 | 0 | A | 0 | 0 | A | 0 | 0 |
| 2 | 2 | A | 0.3 | A | 0.4 | A | 0 | 0 | A | 0 | 0 | A | 0 | 0 |
| 3 | 3 | A | 0.3 | A | 0.3 | A | 0 | 0 | A | 0 | 0 | A | 0 | 0 |
| 4 | 4 | A | 0.3 | A | 0.4 | A | 0 | 0 | A | 0 | 0 | A | 1 | 0 |
| 5 | 5 | A | 0.3 | A | 0.3 | A | 0 | 0 | A | 0 | 0 | B | 3 | 0 |
| 6 | 6 | B | 0.6 | C | 1.6 | B | 2 | 0 | A | 0 | 0 | C | 5 | 0 |
| 7 | 7 | A | 0.3 | A | 0.3 | A | 0 | 0 | A | 0 | 0 | A | 0 | 0 |
| 8 | 8 | A | 0.3 | A | 0.3 | A | 0 | 0 | A | 0 | 0 | A | 0 | 0 |
| 9 | 9 | A | 0.3 | A | 0.4 | A | 0 | 0 | A | 0 | 0 | A | 1 | 0 |
| 10 | 10 | A | 0.3 | A | 0.3 | A | 0 | 0 | A | 0 | 0 | A | 0 | 0 |
| 11 | 11 | B | 0.8 | C | 1.8 | A | 0 | 0 | A | 0 | 0 | C | 6 | 0 |
| 12 | 12 | A | 0.3 | A | 0.3 | A | 0 | 0 | A | 0 | 0 | B | 3 | 0 |
| 13 | 13 | A | 0.3 | B | 1.1 | A | 0 | 0 | A | 0 | 0 | B | 3 | 0 |
| 14 | 14 | A | 0.3 | A | 0.4 | A | 0 | 0 | A | 0 | 0 | A | 0 | 0 |
| 15 | 15 | A | 0.3 | A | 0.3 | A | 0 | 0 | A | 0 | 0 | A | 0 | 0 |
| 16 | 16 | A | 0.3 | A | 0.4 | A | 0 | 0 | A | 0 | 0 | A | 0 | 0 |
| 17 | 17 | A | 0.3 | A | 0.4 | A | 0 | 0 | A | 0 | 0 | A | 0 | 0 |
| 18 | 18 | A | 0.4 | B | 1.1 | A | 0 | 0 | A | 0 | 0 | B | 3 | 0 |
| C.E. 1 | 19 | C | 1.8 | D | 4.2 | C | 8 | 0 | B | 3 | 0 | D | 11 or more | 2 |
| C.E. 2 | 20 | A | 0.3 | B | 1.2 | B | 3 | 0 | A | 0 | 0 | D | 11 or more | 6 |
| C.E. 3 | 21 | A | 0.3 | A | 0.4 | B | 2 | 0 | B | 2 | 0 | D | 11 or more | 3 |
| C.E. 4 | 22 | C | 2.2 | D | 4.6 | C | 6 | 0 | A | 0 | 0 | D | 11 or more | 4 |
| C.E. 5 | 23 | A | 0.3 | A | 0.3 | B | 3 | 0 | B | 3 | 0 | D | 11 or more | 3 |
| C.E. 6 | 24 | A | 0.3 | A | 0.3 | C | 9 | 0 | A | 0 | 0 | D | 11 or more | 4 |
| C.E. 7 | 25 | A | 0.4 | A | 0.4 | C | 7 | 0 | A | 0 | 0 | D | 11 or more | 5 |
| C.E. 8 | 26 | A | 0.3 | B | 0.8 | B | 3 | 0 | B | 2 | 0 | D | 11 or more | 4 |
| C.E. 9 | 27 | A | 0.3 | B | 0.7 | B | 2 | 0 | B | 2 | 0 | D | 11 or more | 3 |

In the Table 5, “C.E.” indicates “Comparative Example”.

### Comparative Examples 1 to 9

In Comparative Examples 1 to 9, toners 19 to 27 were used as toners and subjected to the evaluations described above. The evaluation results are shown in Table 5.

Good results were obtained for all evaluation items with Working Examples 1 to 18. However, Comparative Examples 1 to 9 were inferior to the working examples in terms of cleaning performance evaluations carried out after changes in temperature and humidity.

In view of the results shown above, the present disclosure can provide a toner which exhibits good cleaning performance even in cases where changes occur in the temperature and humidity of a usage environment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-076051, filed May 2, 2023, which is hereby incorporated by reference herein in its entirety.

What is claimed is:

1. A toner comprising a toner particle comprising a binder resin, and an external additive, wherein
the external additive comprises a hydrotalcite particle,
the toner comprises fumaric acid, and
when a content of the hydrotalcite particle in the toner on a mass basis is denoted by a (%) and a content of the fumaric acid in the toner on a mass basis is denoted by b (%),
then the a and the b satisfy formula (1) below:
$$1. \leq a / b \leq 300. . \qquad ( 1 )$$

2. The toner according to claim 1, wherein the content a (%) of the hydrotalcite particle in the toner on a mass basis is 0.05 to 0.50%.

3. The toner according to claim 1, wherein a number average particle diameter of primary particles of the hydrotalcite particle is 60 to 1000 nm.

4. The toner according to claim 1, wherein the content b (%) of the fumaric acid in the toner on a mass basis is 0.003 to 0.120%.

5. The toner according to claim 1, wherein the hydrotalcite particle comprises fluorine, aluminum and magnesium.

6. The toner according to claim 1, wherein in line analysis of the toner in STEM-EDS mapping analysis,
fluorine and aluminum are present in the inner part of the hydrotalcite particle, and
a concentration ratio of the number of fluorine atoms relative to aluminum atoms (F/Al) in the hydrotalcite particle, as determined by primary component mapping of the hydrotalcite particle in STEM-EDS mapping analysis of the toner, is 0.01 to 0.60.

7. The toner according to claim 1, wherein the toner particle contains the fumaric acid.

8. The toner according to claim 1, wherein when, in the toner, a content on a mass basis of the fumaric acid extracted from the toner using methanol is denoted by f1(%), then a value of f1 is 0.0003 to 0.0100%.

9. A process cartridge which can be attached to, and detached from, an electrophotographic image forming apparatus, wherein
the process cartridge comprises:
a latent image bearing member;
a developing means for developing an electrostatic latent image on an outer surface of the latent image bearing member by using a toner; and
a cleaning blade for removing toner on the outer surface of the latent image bearing member following development, and
the toner is the toner according to claim 1.
